(19) United States
(12) Patent Application Publication
(10) Pub. No.: US 2022/0179971 A1
(43) Pub. Date: Jun. 9, 2022

(54) INTERVAL PRIVACY

(71) Applicant: Regents of the University of Minnesota, Minneapolis, MN (US)

(72) Inventor: Jie Ding, Minneapolis, MN (US)

(21) Appl. No.: 17/538,246

(22) Filed: Nov. 30, 2021

Related U.S. Application Data
(60) Provisional application No. 63/119,811, filed on Dec. 1, 2020.

(51) Int. Cl. G06F 21/60; G06N 20/00

(52) U.S. Cl. CPC G06F 21/60; G06F 2221/2115; G06N 20/00

(57) ABSTRACT

A method includes, for each of a plurality of values stored in a computer memory, requesting a set of intervals for the value; receiving the set of intervals such that different values have different sets of intervals; determining which interval the value falls within; and storing the interval that the value falls within as part of public interval data that does not identify the value.

### CROSS-REFERENCE TO RELATED APPLICATION

The present application is based on and claims the benefit of U.S. provisional patent application Ser. No. 63/119,811, filed Dec. 1, 2020, the content of which is hereby incorporated by reference in its entirety.

### BACKGROUND

Some of the most effective uses of computers involve analyzing data to determine patterns. These patterns can include the distribution of a single variable across a population or the relationships between different variables.

In general, there are two types of data: public data and private data. Public data is information that people and entities do not mind sharing with the world. Private data is information that people and entities do not want shared with others. For example, medical information, political opinions and financial activities. At times, people must release their private information in order obtain something they want such as medical care or a loan. However, even in these situations, the person releasing their information has an expectation that the information will be kept in confidence.

Because of this confidentiality, the vast amount of collected private information stored on computer systems is under-utilized since it cannot be released to a third party for analysis.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes, for each of a plurality of values stored in a computer memory, requesting a set of intervals for the value; receiving the set of intervals such that different values have different sets of intervals; determining which interval the value falls within; and storing the interval that the value falls within as part of public interval data that does not identify the value.

In accordance with a further embodiment, a computer-implemented method secures values from disclosure to a third party by performing steps for each value. The steps include obtaining at least two intervals for the value such that different ones of the values have different intervals; determining which of the at least two intervals the value is found in; and providing an indication of which of the at least two intervals the value is found in without providing the value itself to the third party.

In accordance with a still further embodiment, a system includes a memory holding values in a secure manner to prevent disclosure of the values and a processor executing instructions to perform steps. The steps include, for each of a plurality of the values held in a secure manner, obtaining a set of intervals; determining which interval the value is from; storing the set of intervals and which interval the value is from in the memory; and providing access to the set of intervals and the interval the value is from without providing access to the value itself.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a depiction of an I-I interval mechanism.

FIG. 2 provides a depiction of an I-P-I interval mechanism.

FIG. 3 provides a depiction of an I . . . I interval mechanism.

FIG. 4(a) provides a PCA projection of raw data.

FIG. 4(b) provides a PCA projection of surrogate data of the raw data of FIG. 4(a) using a covariance of the raw data.

FIG. 4(c) provides a PCA projection of surrogate data of the raw data of FIG. 4(a) using a covariance of the surrogate data.

FIG. 5(a) provides results of CCA on raw data.

FIG. 5(b) provides results of CCA on surrogate data of the raw data of FIG. 5(a) with a,b determined from the raw data.

FIG. 5(c) provides results of CAA on surrogate data of the raw data of FIG. 5(a) with a,b determined from the surrogate data.

FIG. 6 provides a graph of mean squared L₂ loss for different estimators.

FIG. 7 provides a graph of the difference of estimated and population distributions for different estimators.

FIG. 8 provides a chart of privacy leakage for different actions using three different measures of privacy.

FIG. 9 provides two example cases of privacy leakage.

FIG. 10 provides graphs of the powers of several independence tests.

FIG. 11 provides a block diagram of a system for providing privatized interval data to a data collector.

FIG. 12 is a flow diagram of a method of providing privatized interval data in accordance with one embodiment.

FIG. 13 is a block diagram of a system for generating models from private data without disclosing the private data.

FIG. 14 is a flow diagram of a method of generating models from private data without disclosing the private data.

FIG. 15 is a block diagram of a computing device that can be used in the various embodiments.

### DETAILED DESCRIPTION

The embodiments described below provide an improved computer system that secures private data while allowing processes to accurately run on the private data. In particular, for each private datum, the embodiments obtain a randomly generated set of intervals and determine which of intervals the datum is in. The interval that the datum is in and the anchor points of the intervals for the datum are saved for use by an untrusted data collector. Because the intervals are randomly generated, the data collector is able to perform the same processes on the interval data that the data collector would have been able to perform on the private data such as determining relationships represented by the data, determining distributions of the data, and using the data to train learning algorithms, for example. Thus, the system secures the private data from the data collector but continues to provide a truthful representation of the private data that can be used in many processes including in the generation of artificial intelligence systems based on the interval data.

The choice of the intervals affects the privacy-utility tradeoff. Consider an extreme case where the number of intervals is sufficiently large. Then each interval becomes narrow and the privacy coverage tends to zero. In another case, where only a small number of intervals is provided, the number of values covered by each interval is large and the information provided by indicating that a value is in an interval is of little utility.

Below, the privacy provided by the present embodiments is described mathematically.

Definition 1 (Interval Privacy).

A mechanism M has the property of interval privacy, if for all x₁, x₂∈S_{z},

$$\frac{{p}_{X \vert Z} ( {x}_{1} \vert Z = z )}{{p}_{X \vert Z} ( {x}_{2} \vert Z = z )} = \frac{{p}_{X} ( {x}_{1} )}{{p}_{X} ( {x}_{2} )} \qquad ( 1 )$$

where p_{X|Z} denotes the distribution of X conditional on Z and S_{z} is the essential support of X given Z=z.

Definition 2 (Privacy Coverage).

The privacy coverage of M, denoted by τ (M), is defined by E(L(S_{Z})) where the expectation is over both Y, Z. The privacy leakage from mechanism M is defined by κ(M)=1−τ (M). We say that M has the property of κ-interval privacy if κ(M)≤κ.

One way to estimate E(L(S_{Z})) is to use Eₙ(Lₙ(S_{Z})) where the subscript n denotes the empirical expectation or probability. In this way, we do not need to estimate the distribution function of X. An alternative way to quantify the privacy leakage is through the mutual information between observed data and raw data. For example, observing an interval (−∞, u] or (u, ∞) with u around the median of y gives about one bit of information. The tradeoff between effective sample size and information loss may be derived on a case-by-case basis. Evaluating the information-theoretic quantity often requires the estimation of density functions and may not be computationally easy.

Interval privacy means that the conditioning on Z=z does not provide extra information except that x falls into Sz. If x₁ does not equal x₂, and they fall into the same support S_{z}, then their likelihood ratio remains the same as if no action is taken. Interval privacy also implies that

p_{X|Z}(x|Z=z)=c_{z}1_{x∈s}_{_{z}}·p_{X}(x)

where 1 is an indicator function, holds for the normalizing constant c_{z}=1/∫ₛ_{_{Z}}p_{X} (x)dx.

Suppose that X=x₁ is to be protected, interval privacy creates ambiguity by obfuscating the true x₁ with sufficiently many x₂'s in a neighborhood whose posterior ratios do not vary by incorporating the new information Z=z. Also, suppose that S_{Z} is a (closed or open) interval, then the finite cover theorem implies the following alternative to the above second condition. For all x in the interior of S_{z}, there exists an open neighborhood of x, U(x)∈S_{z}, where interval privacy holds for all x₁, x₂∈U(x).

In addition, by its definition, the privacy coverage _{T}(M) takes values from [0, 1]. The privacy coverage quantifies the average amount of ambiguity or the level of privacy. A larger value indicates increased privacy. Likewise, for each pair of [x, z] (nonrandom), we introduce L(Sz) as the individual privacy coverage, interpreted as the privacy level for a particular datum being collected. To realize interval privacy, we will introduce a natural interval mechanism that converts x to a random interval that contains x. In such a scenario, S_{z} will be in the form of [1, r], and thus L(S_{z})=r−1.

### General Interval Mechanism and Data Format

In the general case, a raw data point x∈ [symbol] is ‘observed’ as an interval that covers it, and a particular case is when the interval degenerates to the exact point x. For multi-dimensional data, we will privatize each entry of it. Let X denote a generic raw data to be privatized so that X˜Fₓ. Within an interval privacy mechanism, the observed data is not X itself, but a privatized data Z generated in the following way: Partition the data domain Y⊂ [symbol] into disjoint intervals. Report the interval which X falls. If the reported interval is pre-marked, the point value of X is further collected. The resulting data would be in the form of a mixture of intervals and points. Formally, we introduce the following notations.

Suppose that the domain Y is partitioned into m intervals in the form of (Uᵢ₋₁, Uᵢ] for i=1, . . . , m, where U₀=−∞ and Uₘ=∞. Let I:(Q, Y) 1→i denote the indicator function where I(Q, Y)=i means X falling into (Uᵢ₋₁, Uᵢ], for i=1, . . . , m. Alternatively, we may use m indicator variables 1_{X}<Uᵢ to represent where X is located at, i=1, . . . , m. By definition, 1_{X≤u}_{ᵢ}=1 if i≤I and 1_{X<U}_{ᵢ}=0 otherwise. Suppose that if X falls into a pre-determined set C⊆ [symbol] , named as the ‘exposure’ set, then the value of X will be known. We consider C to be one of the intervals, say (Uᵢ₋₁, Uᵢ], or empty. An empty set C corresponds to the particular case where all observables are intervals. In general, Q={Q₁, . . . , Qₘ} denote a set that represents a partition of Y, where each Qⱼ is assumed to be a Borel set.

Definition 3 (Interval Mechanism).

A privacy mechanism M: X1→Z maps each given X to the following Z,

Z=[Uᵢ,Δᵢ,i=1, . . . ,m−1,X· [symbol] _{U}_{_{i*−1}}_{<X≤U}_{_{i*}}] (2)

where Δᵢ=1_{U}_{_{i−1}}_{<X≤U}_{ᵢ}. For notational convenience, we also define Δₘ=1−Σᵢ₌₁^{m-1}ΔᵢIn general, we observe n i.i.d. data of Z. Let Fₓ and F_{u,v} denote the CDFs of X and U, respectively. Suppose that Fₓ is unknown while F_{u,v} is known. It can be shown that the interval censoring mechanism M satisfies the interval privacy if E is independent with X.

### Fundamental Properties of the Interval Mechanisms

Suppose that there are k observers/adversaries, each using a mechanism and observing information. These k observers may choose to collaborate to narrow down the range where a particular X falls. This motivates the following ensemble mechanism, denoted by ⊕ⱼ₌₁^{k}Mⱼ, which is itself an interval mechanism.

Definition 4 (Ensemble Mechanism).

The ensemble of two privacy mechanisms

[symbol]

₁:X [symbol] Z={Uᵢ,I(Qᵢ,Y),X·1_{XϵC}_{₁} (3)

with i=1, 2 is defined by

[symbol]

₁⊕ [symbol] ₂:X [symbol] Z={U₁⊕U₂,I(Q₁⊕U₂,Y),X·1_{XϵC}_{₁}_{∪C}_{₂} (4)

where U₁⊕U₂ denotes the finer partition of U₁ and U₂, and C₁∪C₂ denotes the union of two sets C₁, C₂. In general, the ensemble of k privacy mechanisms, denoted by is ⊕ᵢ₌₁^{k}Mᵢ, is recursively defined by ⊕ᵢ₌₁^{k}Mᵢ=M₁⊕ . . . ⊕Mₖ₋₁)⊕Mₖ(k≥2).

This leads to the following:

(a) Composition Property. Suppose that there are k (ensemble) interval mechanisms Mⱼ, j=1, . . . , k. Then k(⊕ⱼ₌₁^{k}Mⱼ)≤Σⱼ₌₁^{k}k(Mⱼ).
(b) Robustness to Preprocessing. For any interval mechanism M, it holds that κ(M_{g})≤κ(M), where the equality holds if and only if g⁻¹(x) has zero Fₓ-measure for all \tilde{x}∈g(Y).
(c) Robustness to Post-processing. Suppose that M:X1→Z is an interval mechanism with κ-interval privacy. Let f:Z1→W be an arbitrary deterministic or random mapping that defines a conditional distribution W|Z. Then f∘M:X→[Z, W] also meets K-interval privacy.

The amalgamation of composition property and robustness to post-processing permit modular design and analysis of interval privacy mechanisms: if each system element that accesses sensitive data is separately interval-private, so will be their combination or consequent post-processing. We will elaborate on some specific uses of the interval mechanism in the following sections.

### Some Interval Privacy Mechanisms

We introduce the following privacy mechanisms.

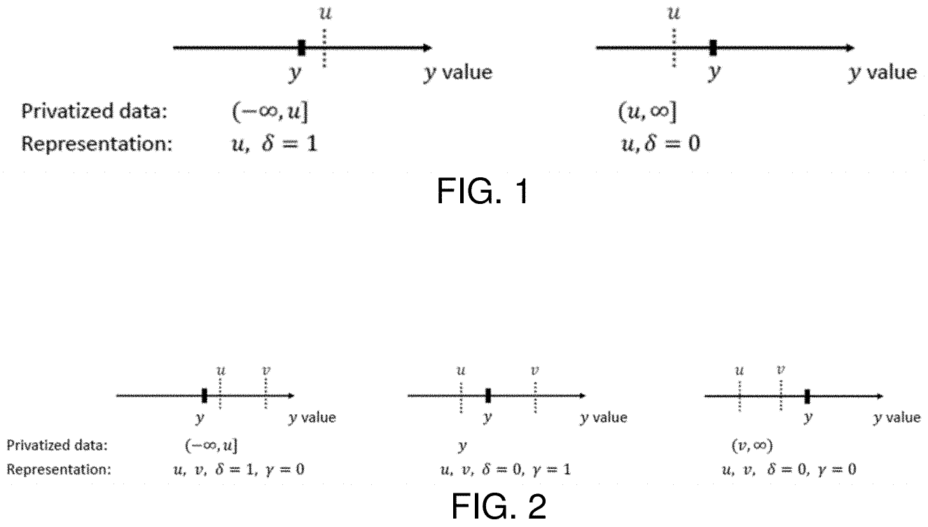

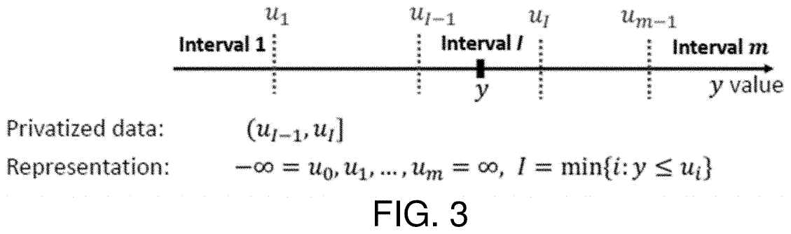

(a) The I-I interval mechanism (illustrated in FIG. 1) is M:X1→Z=[U, Δ], where Δ=1_{X≤U.}
(b) The I-P-I Interval Mechanism (illustrated in FIG. 2) is M:X1→Z=[U, V, Δ, Γ, ΓY], where Δ=1_{X≤U}, Γ=1_{U<x≤v}, and [U, V] is independent with X with [symbol] (U<V)=1.
(c) The P-I-I Interval Mechanism is M:X1→Z=[U, V, Δ, Γ, ΔY], where Δ=1_{X≤U}, Γ=1_{U<X≤U}, and [U, V] is independent with X with [symbol] (U<V)=1.
(d) Suppose that [U₁, . . . , Uₘ₋₁] are random variables with [symbol] (U₁< . . . <Uₘ₋₁)=1. Let U₀=−∞, Um=∞ for notational convenience. The I- . . . -I Interval Mechanism (illustrated in FIG. 3) is

[symbol]

:X [symbol] Z=[U₁, . . . ,Uₘ₋₁,Δ₁, . . . ,Δₘ₋₁] (5)

The discussion above provides a description of the privacy attainable using intervals in place of actual values. Although using intervals provides privacy, it also creates technical challenges for the data analyst when they are attempting to analyze the actual values but only have access to the intervals. A number of different embodiments are provided below for using the intervals to produce an analysis of the hidden actual values.

In accordance with one embodiment, the mean of the distribution of X is estimated from the interval data. For example, suppose that the raw data are i.i.d. Xᵢ∈[a, b] for i=1, . . . , n, with unknown mean μ. The observations are Zᵢ=[Uᵢ, Δᵢ], i=1, . . . , n, from the I-I interval mechanism with U_{i˜i.i.d}. Uniform[a, b]. In accordance with one embodiment, the mean is estimated as:

$${\hat{μ}}_{n} = \frac{1}{n} {\sum }_{i = 1}^{n} ( {Δ}_{i} ( 2 {U}_{i} - b ) + ( 1 - {Δ}_{i} ) ( 2 {U}_{i} - a ) ) \qquad ( 6 )$$

This estimation works in part because Uᵢ is different and random for each observation Zᵢ. As a result, over the sample set, the information about which interval each data value is in takes on the distribution of the underlying values.

In accordance with another embodiment, a method is provided for estimating a regression function from the interval data.

### Formulation

Suppose that we are interested in estimating the regression function with X being the response variable and Y=[Y₁, . . . , Yₚ]∈Rₚ being predictors. Suppose that X has been already privatized, and we only access an interval-private observation of X, while the data Y is fully visible. This scenario occurs, for example, when Alice (who holds X) sends her privatized data to Bob (who holds Y) to seek Assisted Learning. The scenario also occurs when X has to be private while Y is already publicly available.

Following the typical setting of regression analysis, we postulate the data generating model X=f*(Y)+ε, where f* is the underlying regression function to be estimated, and ε˜F_{ε} is an additive random noise. We suppose that Y is a random variable independent of ε, and that F_{ε} is a known distribution, say Gaussian or Logistic distributions.

Suppose that I-I or I-P-I intervals are used, then the data are n observations in the form of

Dᵢ=[μᵢ,δᵢ,yᵢ]^{T} or Dᵢ=[μᵢ,υᵢ,δᵢ,γᵢyᵢ]^{T} (7)

i=1, . . . , n. The function f* is unknown. A parametric approach typically models f* by a linear function in the form of X=Y^{T}β+ε, where β∈ [symbol] ^{p} is treated as an unknown parameter, and ε˜F_{ε}. The above model includes parametric regression and nonparametric regression based on series expansion with bases such as polynomials, splines, or wavelets. Suppose a data analyst is to estimate β from Dₙ. A classical approach is by maximizing the likelihood function which can be written as Πᵢ₌₁ⁿ[F_{ε}(uᵢ−yᵢ^{T}β)^{δ}^{ᵢ}{1−F_{ε}(uᵢ−xyᵢ^{T}β}^{1-δ}^{₁}].

Though the likelihood approach is principled for estimating a parametric regression, its implementation depends on the specific parametric form of the regression function f, and its extension to nonparametric function classes is challenging. In supervised learning, data analysts typically use a nonparametric approach, such as various types of tree ensembles and neural networks. However, the observables are intervals in the form of [L, R], and existing regression techniques for point-valued responses (X) cannot handle interval-valued labels. As such, we are motivated to “transform” the interval-data format into the classical point-data format, to enable direct uses of existing nonparametric regression methods and software packages.

### Interval Regression by Iterative Transformations

Our main idea is to transform the data format from intervals to point values. Ideally, we hope to transform [L, R] to a single point so that classical methods are readily applicable. We propose to use

\tilde{X}= [symbol] (X|D,Y) (8)

as a surrogate to X. This is motivated from the observation that \tilde{X} is an unbiased estimator of f(y) for a given Y=y, namely [symbol] (\tilde{X}|y)= [symbol] (X|y)=f(y). It is worth noting that we cannot use \tilde{X}= [symbol] (X|D), because its expectation is [symbol] (X) instead of [symbol] (X|y), and thus this surrogate will produce a large estimation error.

In general, suppose that we choose a loss function £: X×X→ [symbol] such as L₁ or L₂ loss. Based on the above, it is tempting to solve the following optimization problem

$$\begin{matrix}{min}_{f ∈ ℱ} {\sum }_{i = 1}^{n} ℓ ( {\tilde{X}}_{i} , f ( Y ) ) & ( 9 ) \\ where {\tilde{X}}_{i} = 𝔼 ( X \vert D , Y ) = f ( Y ) + 𝔼 ( ɛ \vert D , Y ) & ( 10 )\end{matrix}$$

The following result justifies the validity of using \tilde{X} as a surrogate of X to estimate f, if the \tilde{X}ᵢ were computable. We define the norm of f to be ∥f∥ [symbol] _{Y}= [symbol] (f(Y)²). Suppose that the underlying regression function f*∈F where F is a parametric or nonparametric function class with bounded L₂ ( [symbol] _{Y})-norms. The next result shows that the optimal f obtained by minimizing (13) with a squared loss £ is asymptotically close to the underlying truth f*. For notational convenience, we will let [symbol] ₙ(\tilde{X}−f(Y))²=n⁻¹Σᵢ₌₁ⁿ(\tilde{X}ᵢ−f(Yᵢ))² denote the average squared loss.

Suppose that

[symbol]

| [symbol] ₙ(\tilde{X}−f(Y))²− [symbol] (\tilde{X}−f(Y))²|→ₚ0 (11)

as n→∞. Then any sequence \hat{f}ₙ that maximizes [symbol] ₙ(\tilde{X}−f(Y))² converges in probability to f*, meaning that ∥\hat{f}ₙ−\hat{f}*∥ [symbol] _{Y}→ₚ0. as n→∞.

In practice, however, the calculation of \tilde{X} itself is unrealistic as it involves the knowledge of f(Y). In other words, the unknown function f appears in both the optimization (9) and calculation of surrogates (10). The above difficulty motivates us to propose an iterative method where we iterate the steps in (9) and (10), using any commonly used supervised learning method to obtain \hat{f} at each step.

The pseudocode is provided in Algorithm 1, where I-I intervals are considered for brevity.

Algorithm 1 Regression from Interval Response by
Iterative Transformation (a Case-I-I example)

Input: Interval-valued responses Dᵢ, in Eq. (11) and predictors yᵢ ∈ [symbol] ^{p}, i = 1, ..., n , function class

| | |
|---|---|
| | [symbol] , error distribution function [symbol] _{ε} |
| | Initialization: Round k=0, function \hat{ƒ}₀(•) |
| 1: | repeat |
| 2: | Let k ← k + 1 |
| 3: | Update the representative \tilde{x}ᵢ, i = 1,..., n |
| | \tilde{x}ᵢ = \hat{ƒ}ₖ₋₁(yᵢ) + [symbol] |
| | (ε\|ũᵢ, δᵢ, yᵢ) (12) |
| | where ũᵢ = uᵢ − \hat{ƒ}ₖ₋₁(yᵢ). |
| 4. | Fits a supervised model \hat{ƒ}ₖ using (\tilde{x}ᵢ, yᵢ) as labeled data by |
| | optimizing (9) using a preferred |

method

| | |
|---|---|
| 5 | until Stop criterion satisfied (e.g. if the fitted values no longer change much) |

Output: The estimated function \hat{ƒ}ₖ: [symbol] ^{p} →

[symbol]

We provide a theoretical guarantee of its convergence for linear regression models. In practice, we set the initialization by \hat{f}₀(y)=0 for all y. We experimentally found that Algorithm 1 is robust and works well for a variety of nonlinear models, including tree ensembles and neural networks.

Suppose that the underlying true regression function is f*(y)=y^{T}β*, β*∈ [symbol] ^{p}, and the least squares estimate \hat{β}ₖ is used in (9). Assume that ε is supported on [symbol] with [symbol] (ε)≤∞, the CDF F_{ε}(•) of ε is continuously differentiable. Also assume that |U−f*(Y)| is almost surely bounded by a constant B, and sup_{v:|v|≤B|}1+G_{ε}(v)p_{ε}(v)/{F_{ε(v)(}1−F_{ε}(v))}|<1, where p_{ε}is the density of ε and G_{ε}(v)=∫_{-∞}^{v}ydF_{ε}(y). Then there exists a constant δ>0 such that for all initial values β₀ satisfying ∥\hat{β}₀−β*∥<δ, we have lim_{n,k→∞}∥\hat{β}ₖ−β*∥=0 in probability.

The term [symbol] (ε|ũ, δᵢ, yᵢ) is essentially a conditional mean indicated by δᵢ, or [symbol] (ε|ε≤uᵢ−\hat{f}ₖ₋₁(yᵢ)) if δᵢ=1 and [symbol] (ε|ε<uᵢ−\hat{f}ₖ₋₁(yᵢ)) otherwise. In implementing Algorithm 1, we need to specify a distribution for the error term £ when calculating (12). In general, the learning accuracy can be suboptimal if a data analyst postulates a model that violates the underlying data generating process, an issue known as model mis-specification y. Nevertheless, in our context of data-private regression, we found from various experiments that the accuracy of estimating regression functions is not sensitive to mis-specification of the noise distribution. We conjecture that the consequent estimation of the regression function is still consistent under mild conditions. A practical suggestion to data analysts is to treat £ as Logistic random variables to simplify the computation. Also, if the standard deviation of the noise term £ is unknown in practice, we suggest estimate σ² with n⁻¹ Σᵢ₌₁ⁿ(xᵢ−\tilde{x}ᵢ)² at each iteration of Algorithm 1.

### Experiments

### Estimation of Moments

In this experiment, we demonstrate interval-private data (with reasonably broad privacy coverage) in moment estimation. Suppose that 100 raw data are generated from X˜N (0.5, 1), and the private data we collect is based on the I-I mechanism with U E Uniform[−T, T], where T=2n^{1/3}. The goal is to estimate [symbol] (X). We demonstrate three methods and compare them with the (unrealistic) estimates based on the raw data in Table 1. The first method, denoted by ‘Example 2’, uses the estimator in (6). The second method, denoted by ‘NPMLE’, uses the nonparametric maximum likelihood approach available from the ‘Icens’ R package (Gentleman and Vandal, 2010). The third method, denoted by ‘MLE’, presumes that the distribution is Gaussian with unknown mean and variance, and estimates the mean with the standard maximum likelihood principle. Unlike the above two methods, the third one requires the knowledge of a parametric form and is thus expected to converge faster. We also consider two methods based on the raw data in hindsight: the sample average and the sample median. To demonstrate the robustness of interval data, we add none, 1%, and 5% proportion of outliers (where X is set to be 999). We also considered the estimation of [symbol] (Y²), where we used a similar procedure to collect interval-private Y², except that U∈Uniform[0, 2T] so that the privacy coverage remains to be about 0.95 (or 5% leakage).

Table 1 summarizes the results, which indicate that the estimation under highly private data is reasonably well when compared with the oracle approach (under 0% outlier). The interval-private data tend to be more robust against outliers than the estimation based on simple mean and comparable to the median (based on raw data).

### Estimation of Regression Functions

In this experiment, we estimate the linear regression model X=f(Y)+ε, where f(Y)=βy is to be estimated from the I-I privatized data Z=[U, Δ]. We generate n=200 data with β=1, ε˜N (0, 1), U a Logistic random variables with scale 5. The corresponding privacy coverage is around 0.9. The prediction error is evaluated by mean squared errors [symbol] (f(\tilde{Y})−\hat{f}(\tilde{Y}))² where \tilde{Y} denotes the unobserved (future) data. With a limited size of data, the algorithm will produce an estimate \hat{f}(y)=\hat{β}Y that converges well within 20 iterations. The initialization is done by simply setting \hat{f}₀(y)=0.

In another experiment, we demonstrate the method proposed above on the nonparametric regression model X=f(Y)+ε, using the I-P-I privatized data Z=[U, V, Δ, Γ]. Suppose that n=200 data are generated from quadratic regression f(Y)=Y²−2Y+3, and ε˜N(0, 1). Let U=min(L₁, L₂), V=max(L₁, L₂), where L₁, L₂ are independent Logistic random variables with scale 5. The corresponding privacy coverage is around 0.9. Random Forest (depth 3, 100 trees) with features Y₁=Y, Y₂=Y² are used to fit Algorithm 1. With a limited size of data, the algorithm will produce a tree ensemble estimate that converges well within 20 iterations.

TABLE 1
Mean absolute errors of estimating [symbol] (Y) and [symbol]
(Y) using interval-private data and raw data (in hindsight),
where Y~N (0.5, 1), subject to 0%, 1%, and 5% outliers.
Errors were calculated from 1000 independent replications
so that the standard errors are all within 0.01.

| | Estimate [symbol] (Y) | | | | Estimate [symbol] (Y²) | | |
|---|---|---|---|---|---|---|---|
| | n | 0% | 1% | 5% | 0% | 1% | 5% |
| Private data | 100 | 0.81 | 0.74 | 0.56 | 0.79 | 0.82 | 1.03 |
| (Example 2) | 1000 | 0.77 | 0.57 | 0.38 | 0.57 | 0.64 | 1.96 |
| Private data | 100 | 0.53 | 5.17 | 5.14 | 9.34 | 9.38 | 9.54 |
| (NPMLE) | 1000 | 0.43 | 0.49 | 0.54 | 27.93 | 29.37 | 28.41 |
| Private Data | 100 | 0.52 | 4.78 | 4.74 | 8.85 | 8.89 | 8.89 |
| (MLE) | 1000 | 0.43 | .095 | 0.97 | 6.62 | 6.53 | 6.72 |

In the examples above, the intervals are used directly to estimate the mean and to determine the linear regression. In other embodiments, referred to herein as D-transformations, the intervals are transformed to points whose conditional expectation (averaging over the randomness of intervals) equal to the raw values.

### D-Transformation Method: A General Description

This section addresses a general design, where data falling into the middle interval are observed. As before, we suppose that the distribution of x is denoted by F, and the distribution of U=[U₁, . . . , Uₘ₋₁] is Fᵤ(u). Assume that U and X are independent. Let Δᵢ be defined in a similar way as in Definition 3. We will elaborate on specific designs, including the I-I, I-P-I, I-I-P, I- . . . -I designs mentioned above.

Given n observations of Z=[Uᵢ, Δᵢ, i=1, . . . , m−1, denoted by zⱼ=[u_{i,j}, δ_{i,j}, i=1, . . . , m−1], j=1, . . . , n, our goal is to find a suitable surrogate of each unobserved/latent xⱼ, denoted by \tilde{x}ⱼ. We consider an unbiased estimator of xⱼ, so that E(\tilde{x}|xⱼ)=xⱼ, where the expectation is with respect to the distribution of uⱼ. Since we assume the data [xᵢ, uⱼ], j=1, . . . , n, are i.i.d., our goal is to construct a random variable \tilde{X} that satisfies

[symbol]

(\tilde{x}|X=x)=x (13)

A natural choice is \tilde{x}=Σ_{i=1, . . . , m, i≠i*} [symbol] (Y|Uᵢ₋₁<X≤Uᵢ)+Δ_{i*y}, since direct calculations show that (13) holds. Unfortunately, Fₓ is usually unknown in practice, so we cannot easily compute each conditional expectation [symbol] (Y|Uᵢ₋₁<X≤Uᵢ).

Alternatively, we consider a surrogate \tilde{X} in the following form

$$\tilde{X} = {\sum }_{i = 1 , … , m , i \neq {i}_{*}} {Δ}_{i} {Φ}_{i} ( U ) + {Δ}_{{i}_{*}} {Φ}_{i *} ( x ) \qquad ( 14 )$$

where Φ₁, . . . , Φₘ are some fixed measurable functions that do not depend on x or its underlying distribution and that are easy to evaluate. In other words, if x is known to fall into interval (Uᵢ₋₁, Uᵢ], then let \tilde{X}=Φᵢ(U); moreover, if x is exactly observed, then simply let \tilde{x}=x. Note that \tilde{x} is a statistic computable from the observed data Z, while x is not. For \tilde{x} to be an unbiased estimator of x, we will need to design appropriate Φᵢ's, which motivates the following definition.

Definition 5 (D-Transformation).

If the function tuple (Φ₁, . . . , Φₘ) meet the following conditions, we say it is a D-transformation with respect to the distribution of U=[U₁, . . . , Uₘ₋₁], and denote it by (Φ₁, . . . , Φₘ)∈D.

### 1) [Regularity]

$${\sum }_{i = 1 , … , m , i \neq {i}_{*}} {\int }_{{u}_{i - 1} < x \leq {u}_{i}} {Φ}_{i} ( u ) d {F}_{u} ( u ) + {Φ}_{{i}_{*}} ( x ) \{ {F}_{{u}_{*} - 1} ( x ) - {F}_{{u}_{*}} ( x ) \} = x , ∀ x ∈ ℝ \qquad ( 15 )$$

2) [Computability](Φ₁, . . . , Φₘ) may depend on the function F_{u,v}, but will remain the same regardless of F.

The regularity is a condition that will guarantee the unbiasedness of \tilde{X}. In later subsections, we will show that for any given distribution of U, there may exist multiple designs of (Φ₁, . . . , Φₘ that meet this condition. The computability condition says that the surrogate \tilde{X} can be evaluated even without knowing the distribution function of X (which is often the case in practice).

For any (Φ₁, . . . , Φₘ)∈D, we have [symbol] (\tilde{X}|X)=X. Furthermore, [symbol] (\tilde{X})= [symbol] (X).

### Corollary1.

Suppose that in the Definition 6 F_{u,v}, Fₓ are replaced with conditional distributions on R, F_{u,v|r}, F_{x|r}, then [symbol] (\tilde{X}|R)= [symbol] (X|R). In particular, [symbol] (\tilde{X}|X, R)=X, [symbol] (\tilde{X}|X)=X, and [symbol] (\tilde{X})=E(X).

The D-transformation provides a class of unbiased estimators of x. In the sequel, we show two examples. We will assume that EX²<∞, and that H has density f_{u,v} (u, v)>0.

### I-I Design: Two Intervals

This section addresses the I-I design, where the observation is in the form of Z=[U, 1_{X≤U}], where U is generated independently with the data. The surrogate \tilde{X} in (14) becomes the following specific form

\tilde{X}=Φ₁(U)Δ+Φ₂(U)(1−Δ) (16)

and the regularity condition for Φ₁, Φ₂ becomes

∫ₓ^{∞}Φ₁(u)dFᵤ(u)+∫_{-∞}^{x}Φ₂(v)dFᵥ(v)=x. ∀x∈ [symbol] (17)

Then the following is a D-transformation,

$${Φ}_{1} ( u ) = u - \frac{1 - {F}_{u} ( u )}{{f}_{u} ( u )} , {Φ}_{2} ( u ) = u + \frac{{F}_{u} ( u )}{{f}_{u} ( u )} . \qquad ( 18 )$$

The intuition of the above I-I Design 1 is explained as follows. The underlying raw data is only known to fall into either (−∞, U] or (U, ∞); if x is known to be smaller than U, then we surrogate it with U minus a correction term uniquely determined by U; otherwise, we surrogate it with U plus a correction term uniquely determined by U. Note that if X=[a, b] with finite a, b, a similar result holds by replacing −∞ and ∞ with a⁺ and b⁻ respectively. The next result provides another design. Though different designs give an unbiased estimate of x, their variances may be different.

Assume that Fᵤ is continuously differentiable on [symbol] , fᵤ(t)>0 for all t∈R. Then the following pair is a D-transformation,

$${Φ}_{1} ( u ) = \frac{- {e}^{- u}}{{e}^{- u} + {e}^{u}} \frac{1}{{f}_{u} ( u )} , {Φ}_{2} ( u ) = \frac{{e}^{u}}{{e}^{- u} + {e}^{u}} \frac{1}{{f}_{u} ( u )} . \qquad ( 19 )$$

I-P-I Design: Two Intervals Mixed with Mid-Range Points

This section addresses the I-P-I design, where the observation is in the form of Z=[U, V, Δ, Γ], where Δ=n1_{X≤U}, Γ=2_{U<X≤V}. The surrogate \tilde{X} in (14) is in the form of

\tilde{X}=Φ₁(U,V)Δ+Φ₂(x)Γ+Φ₃(U,V)(1−Δ−Γ) (20)

For simplicity, we suppose that Φ₁(u, v) is only a function of u, and Φ₂(u, v) is only a function of v. The regularity condition for Φ₁, Φ₂, Φ₃ becomes

∫ₓ^{b}Φ₁(u)dFᵤ(u)+Φ₂(x){Fᵤ(x)−Fᵥ(x)}+∫ₐ^{x}Φ₃(v)dFᵥ(v)=x, ∀_{y}∈ [symbol] (21)

where Fᵤ and Fᵥ denote the CDF of U and V, respectively. We provide two specific designs below.

(I-P-I Design 1).

Assume that Fu and Fv are continuously differentiable on [symbol] , the support of U, V, fᵤ(t)>0, fᵥ(t)>0 for all t∈R, and

$${lim}_{t \to {b}^{-}} t \{ 1 - {F}_{u} ( t ) \} = 0 , {lim}_{t \to {a}^{+}} t {F}_{v} ( t ) = 0$$

Then the following triplet is a D-transformation.

$${Φ}_{1} ( u ) = u - \frac{1 - {F}_{u} ( u )}{{f}_{u} ( u )} , {Φ}_{2} ( x ) = x , {Φ}_{3} ( v ) = v + \frac{{F}_{v} ( v )}{{f}_{v} ( v )} \qquad ( 22 )$$

The intuition of this design is similar to that of I-I Design 1, except that we use the exact value of x whenever it is observed (i.e. falling into (U, V]). Also, I-I Design 1 can be regarded as a special case of I-P-I Design 1 when U=V.

(I-P-I Design 2).

Assume that the joint density f_{u,v}>0 almost everywhere on the support [symbol] . Then the following triplet is a D-transformation.

$${Φ}_{1} ( u ) = 0 , {Φ}_{2} ( x ) = \frac{x}{{F}_{u} ( x ) - {F}_{v} ( x )} , {Φ}_{3} ( v ) = 0 \qquad ( 23 )$$

The intuition of this design is explained as follows: If x is not observed and only known to fall into two tails, then we truncate it to be simply zero; since this may cause a severe bias, we compensate the truncation by correcting the observed x by a factor that is uniquely determined by U and V.

### Some Example Distributions on U, V

Before we proceed to other mechanisms, we provide some example designs in correspondence to the I-I and I-P-I designs. We focus on the following class of joint distributions of U, V that is often easy to implement in practice.

### Example (U, V Design 1).

We let

U=W−a,V=W+a (24)

where a is a constant that controls the (deterministic) gap between U, V. It can be verified that

fᵤ(u)=f(u+a),fᵥ(v)=f(u−a),Fᵤ(u)=F(u+a),Fᵥ(v)=F(v−a) (25)

Therefore, calculations of Φ₁, Φ₂, Φ₃ can be made in closed-form as long as f, F have closed forms.

### Example (U, V Design 2).

We let

U=min(W₁,W₂),V=max(W₁,W₂) (26)

where W₁, W₂ are independently drawn from F. It can be verified that

fᵤ(u)=2f(u)(1−F(u)),fᵥ(v)=2f(v)F(v),Fᵤ(u)=2F(u)−F(u)²,Fᵥ(v)=F(v)² (27)

Compared with the class in (16), this class does not allow U≈V without reducing the variance of distribution F.

Suppose that the distribution of W (as used in Examples 1 and 2) are generated is the Uniform distribution on [0, c], and X=[0, c]. We calculate the resulting surrogates \tilde{X} in Table 2. This uniform design is not recommended in practice unless x is known to be bounded.

TABLE 2
Uniform with range [0, c]

| | I-P-I Design 1 | | I-P-I Design 2 | |
|---|---|---|---|---|
| | U,V Design 1 | U,V Design 2 | U,V Design 1 | U,V Design 2 |
| Φ₁ | 2u-c + a | $\frac{3 u - c}{2}$ | 0 | 0 |
| Φ₂ | x | x | $\frac{cu}{2 a}$ | $\frac{{c}^{2}}{2 ( c - y )}$ |
| Φ₃ | 2v-a | $\frac{3 v}{2}$ | 0 | 0 |

Suppose that the distribution of W is the Logistic distribution on with CDF

$$F ( w ) = \frac{{e}^{w / s}}{1 + {e}^{w / {s}^{′}}} \qquad ( 28 )$$

with s>0 being a constant. We calculate the resulting surrogates \tilde{X} in Table 3.

TABLE 3
Logistic with scale s

| | I-P-I Design 1 | | I-P-I Design 2 | |
|---|---|---|---|---|
| | U,V | | | |
| | Design 1 | U,V Design 2 | U,V Design 1 | U,V Design 2 |
| Φ₁ | u − s{1 + exp(−(w + a/2)/s)} | $u - \frac{x}{2 F ( u )}$ | 0 | 0 |
| Φ₂ | x | x | {1 + exp((w − a)/s)}⁻¹ − {1 + exp((w + a)/s}⁻¹ | $\frac{x}{2 F ( x ) ( 1 - F ( x ) )}$ |
| Φ₃ | u + s{1 + exp(((w − a/2)/s)} | $v + \frac{s}{2 ( 1 - F ( v ) )}$ | 0 | 0 |

P-I-I Design: Two Intervals Mixed with Left-Tail Points

This section addresses the P-I-I design, where the observation is in the form of Z=[U, V, Δ, Γ], where Δ=1_{X≤U}, Γ=1_{U<X≤V}. The surrogate \tilde{X} in (14) may be written in the form of

\tilde{X}=Φ₁(x)Δ+Φ₂(U)Γ+Φ₃(V)(1−Δ−Γ) (29)

For simplicity, we have assumed Φ₂, Φ₃ to be scalar functions (similarly to the I-P-I Design). The regularity condition for Φ₁, Φ₂, Φ₃ becomes

∫ₓ^{b}Φ₁(u)dFᵤ(u)+Φ₂(x){Fᵤ(x)−Fᵥ(x)}+∫ₐ^{x}Φ₃(v)dFᵥ(v)=x, ∀y∈ [symbol] (30)

We provide two designs below.

### (P-I-I Design 1).

Assume that Fᵤ and Fᵥ are continuously differentiable on [symbol] , the support of U, V, fᵤ(t)>0, fᵥ(t)>0 for all t∈ [symbol] . Then the following triplet is a D-transformation.

$${Φ}_{1} ( x ) = \frac{x}{1 - {F}_{u} ( x )} , {Φ}_{2} ( u , v ) = {Φ}_{3} ( v ) = 0 \qquad ( 31 )$$

The intuition is that we assign 0 to censored data and leverage the weight of censored data. When the distribution H of the censored data is unknown, we could use D-transformation.

### Proposition 6 (P-I-I Design 2).

Assume that Fᵤ and Fᵥ are continuously differentiable on R, the support of U, V, fᵤ(t)>0, fᵥ(t)>0 for all t∈ [symbol] . Then the following triplet is a D-transformation.

$${Φ}_{1} ( x ) = x , {Φ}_{2} ( u , v ) = \frac{{f}_{v} ( v ) - {f}_{u} ( v )}{{f}_{u , v} ( u , v )} , {Φ}_{3} ( u , v ) = v + \frac{{F}_{v} ( v )}{{f}_{v} ( v )} \qquad ( 32 )$$

### I- . . . -I Design: Multiple Intervals

The U=[U₁, . . . , Uₘ₋₁]) may be bounded or unbounded, dependent or independent. Our general method is described as follows. Suppose that [Φ_{1,i}(Uᵢ), Φ_{3,i}(Uᵢ)] is a D-transformation of x for the distribution of U, under I-I Design. Given observation of Z as defined in (5), our key idea is to turn the m-interval problem into many 2-interval problems, and average their corresponding estimators to reduce the overall variance. One possible solution is to consider a surrogate \tilde{X} in the following form

$$\tilde{X} = \frac{1}{m - 1} {\sum }_{i = 1}^{m - 1} \{ {Δ}_{i} {Φ}_{1 , i} ( {U}_{i} ) + ( 1 - {Δ}_{i} ) {Φ}_{2 , i} ( {U}_{i} ) \} where {Δ}_{i} = {1}_{I ( U , X ) \leq i} \qquad ( 33 )$$

where I(U, X)∈{1, . . . , m} denotes such k that X falls into (Uₖ₋₁, Uₖ].

Since each term in the summation is a (conditionally) unbiased estimate of x, their average is still unbiased, while the variance will typically decrease. Sometimes, the distribution of Uᵢ is nontrivial, and thus it is not easy to compute its corresponding Φᵢ and evaluate the variance. We will propose an alternative unbiased estimator that can be much easier to compute compared with (33), whose variance is also provably reduced by m times. Next, we show an example to illustrate the above ideas.

### Example (I- . . . -I Design 1 (Equal Spacing)).

Let W be a random variable whose distribution function and density functions are F_{w} and f_{w}, respectively. Let a>0 be a constant that specifies the distance between two censoring points. We generate U₁, . . . , Uₘ₋₁ (m≥3) in a way similar to Example 1:

Uᵢ=W−(m−2)a+2(i−1)a, i=1, . . . ,m−1 (34)

The marginal distribution function of Uᵢ is therefore F_{w}(uᵢ+(m−2)a−2(i−1)a), which can be used to evaluate (33) using specific designs (e.g. those introduced before).

### Example (I- . . . -I Design 2 (Random Spacing)).

Suppose that one generates U₁, . . . , Uₘ₋₁ (m≥3) by drawing i.i.d. random variables W₁, . . . , Wₘ₋₁ from a distribution function F_{w} (with density function denoted by f_{w}), and let W₀≤ . . . ≤W₍ₘ₋₁₎ be their order statistics. Then we let Uᵢ=W₍ᵢ₎), whose density function fi and distribution function Fᵢ are calculated to be

$${{f}_{i} ( u ) = ( m - 1 ) ( \begin{matrix}m - 2 \\ i - 1\end{matrix} ) f ( u ) {F ( u )}^{i - 1} ( 1 - F ( u ) ) )}^{m - 1 - i} , {F}_{i} ( u ) = {{\sum }_{j = i}^{m - 1} ( \begin{matrix}m - 1 \\ j\end{matrix} ) {F ( u )}^{j} ( 1 - F ( u ) ) )}^{m - 1 - j} \qquad ( 35 )$$

for i=1, . . . , m−1. The Φ₁, Φ₂ in (33) can be further calculated using thereafter. Nevertheless, the variance of \tilde{X} is usually nontrivial to evaluate, mainly because the summation terms in (33) are often dependent. Calculating the pairwise covariance can be challenging. Methods such as Rio's covariance inequality may be used to derive upper bounds of the variance as m increases. To simplify computation and evaluate the variance for the constructed \tilde{X}, we propose the following alternative estimator.

Let [Φ₁, Φ₂] be a D-transformation with respect the distribution function W. The following proposition indicates the following estimator,

$$\tilde{X} = \frac{1}{m - 1} {\sum }_{i = 1}^{m - 1} \{ {Δ}_{i} {Φ}_{1} ( {U}_{i} ) + ( 1 - {Δ}_{i} ) {Φ}_{2} ( {U}_{i} \} , where {Δ}_{i} = {1}_{I ( U , X ) \leq i} \qquad ( 36 )$$

satisfies E(\tilde{X}|X)=X and admits a more tractable variance.

### Proposition.

Suppose that W₁, . . . , Wₘ₋₁ are identically distributed random variables such that the joint distribution of [W₍₁₎, 1_{x≤W(1)}, . . . , W₍ₘ₋₁₎, 1x≤W₍ₘ₋₁₎] is the same distribution as [U₁, Δ₁, . . . , Uₘ₋₁, Δₘ₋₁] for any given x. Here, W₍₁₎≤ . . . W₍ₘ₋₁₎ are the order statistics of W₁, . . . , Wₘ₋₁. Suppose that [Φ₁, Φ₂] is a D-transformation with respect the distribution of W₁. Then the \tilde{X} in (36) is an unbiased estimator of x, and its conditional variance is

$$𝕍 ( \tilde{\tilde{X} \vert X = x ) = \frac{1}{m - 1} 𝕍 \{ {1}_{x} \leq {W}_{1} {Φ}_{1} ( {W}_{1} ) + {1}_{x > {W}_{1}} {Φ}_{2} ( {W}_{1} ) \}} \qquad ( 37 )$$

whenever the right-hand side is bounded.

The identity (37) further implies that

$$𝕍 ( \tilde{X} ) - 𝕍 ( X ) = \frac{𝕍 ( \tilde{\tilde{X}} ) - 𝕍 ( X )}{m - 1} \qquad ( 36 )$$

where \tilde{X} is an independent copy of \tilde{X} with m=2.

The boundedness of V{1_{x≤W}_{₁}Φ₁(W₁)+1ₓ>W₁Φ₂(W₁)} may need to be verified on a case-by-case basis. For example, it can be verified that for the I-I Design 1, a sufficient condition is that

$$𝔼 {U}^{2} < ∞ , {lim sup}_{w \to - ∞} \frac{{F}_{w} ( w )}{{f}_{w} ( w )} < ∞ , {lim sup}_{w \to ∞} \frac{1 - {F}_{w} ( w )}{{f}_{w} ( w )} < ∞ \qquad ( 37 )$$

which hold for common distributions such as Gaussian, Logistic, etc. Suppose that [symbol] (\tilde{X}|X=x) is bounded, then the Proposition above implies that as m increases, [symbol] (\tilde{X}|X=x) monotonically converges to zero. This property is intuitively appealing as more information brought by more intervals tends to reduce the uncertainty of an estimate of x.

### When the Raw Observation Itself is an Interval Instead of a Point

Suppose the raw observation is [X⁽⁻⁾, X⁽⁺⁾] that may or may not be dependent on X, and that contains X almost surely. An example is that [X⁽⁻⁾, X⁽⁺⁾] represents a confidence interval of an unknown parameter X, and the intervals are further collected for meta-analysis. Another example is that a set of interval-privatized data needs to be re-collected by another agent. Suppose that X⁽⁻⁾=X−T⁽⁻⁾, X+T⁽⁺⁾, where T⁽⁻⁾, T⁽⁺⁾∈ [symbol] ⁺ are treated as two nonnegative random variables. Similar to Definition 5(a), the privatized data is obtained in the following way.

Definition 6 (I-I Design with Non-Point Raw Data).

Suppose that the privacy mechanism

[symbol]

:[X⁽⁻⁾,X⁽⁺⁾] [symbol] Z=[U,Δ,Γ] (38)

where

Δ=1_{X(+)≤U}, Γ=1_{X(-)≤U≤X(+)} (39)

and U is independent with Y, X⁽⁻⁾, X⁽⁺⁾.

The privatization is interpreted in the following way: if X⁽⁺⁾≤U, then almost surely Y∈(−∞, U] and we report this interval; if X⁽⁻⁾>U, then almost surely Y∈(U, ∞); otherwise, there is ambiguity and we do not report any interval.

As before, suppose that Fₓ is unknown while Fᵤ is known. We still try to obtain an unbiased estimator of x or [symbol] (Y|R) where R, if non-null, denotes external side information.

We construct an estimator in the form of

\tilde{X}=Φ₁(U)Δ+Φ₂(U)Γ+Φ₃(U)(1−Δ−Γ) (40)

Similar to Definition 5, we have the following result.

### Theorem 3.

Let

$$ρ = \frac{𝔼 ( {T}^{( + )} \vert X )}{𝔼 ( {T}^{( - )} \vert X ) + 𝔼 ( {T}^{( + )} \vert X )} ∈ [ 0 , 1 ] \qquad ( 41 )$$

be a fixed constant. If

∫ₓ_{⁽⁺⁾}^{b}Φ₁(u)dFᵤ(u)+Φ₂(u)dFᵤ(u)+∫ₐ^{x}^{^{(−)}}Φ₃(u)dFᵤ(u)=px⁽⁻⁾+(1−ρ)x⁽⁺⁾, ∀y∈ [symbol] (42)

Then [symbol] (\tilde{X}|X, R)=X for any random variable R that is independent with U.

In particular, (26) holds if

$${Φ}_{1} ( u ) = u - \frac{1 - {F}_{u} ( u )}{{f}_{u} ( u )} , {Φ}_{2} ( u ) = u + \frac{{F}_{u} ( u ) - ρ}{{f}_{u} ( u )} , {Φ}_{3} ( u ) = u + \frac{{F}_{u} ( u )}{fu ( U )} , and {lim}_{t \to b -} t \{ 1 - {F}_{u} ( t ) \} = 0 , {lim}_{t \to a +} {tF}_{u} ( t ) = 0 \qquad ( 43 )$$

The Design in (43) is an analog of that in I-I Design 1, except that there is a correction term brought by Γ=1.

### General Use.

Suppose that Y∈ [symbol] is an unbounded real-valued random variable. We generate a privatized variable Z as introduced in (3), and collect Z for further transmission/storage/learning (see FIG. 1.) Given Z and the distribution of U (designed), one may construct a statistic \tilde{X} using the proposed method above, which is an unbiased estimate of the unobserved raw data Y=y. Suppose there are n i.i.d. copies of Z, then [symbol] ₙ(\tilde{X})=n⁻¹Σⱼ₌₁ⁿ\tilde{X}ⱼ is an unbiased estimate of [symbol] (X) (Theorem 2) and also a consistent estimate of [symbol] (X) if [symbol] (\tilde{X}) is bounded. Similar results hold if the expectation is conditional on any random variable that is independent with U.

Suppose that one is interested in a measurable function of X, say g(X). One possible way is to turn Z into an interval observation for g(X) and apply the same technique. For some distributions of U, this may not be computationally tractable. Alternatively, one would collect an interval observation of g(X) directly. For instance, to estimate V(x), one may choose to observe X and g(X)=X² separately, in order to construct an unbiased estimators of V(X). If so, the overall privacy leakage of X is no larger than the sum of both leakag.

### Variance Inflation.

Though a constructed statistic \tilde{X} satisfies [symbol] (\tilde{X})= [symbol] (X), its variance depends on the interval mechanism. The following inequality holds despite the underlying interval mechanism.

[symbol]

(\tilde{X})= [symbol] ( [symbol] (\tilde{X}|X))+ [symbol] ( [symbol] (\tilde{X}|X))= [symbol] (X)+ [symbol] ( [symbol] (\tilde{X}|X))≥ [symbol] (X) (44)

with equality if and only if \tilde{X}=X almost surely. Intuitively, the uncertainty of \tilde{X} is larger than that of X on average due to the ambiguity brought by intervals. In some regression and classification problems (elaborated in later sections), it is helpful to estimate the original variance of X from the inflated variances [symbol] (\tilde{X}) that can be estimated by its sample analog. In general, an analytical form of [symbol] (\tilde{X}) needs to be derived on a case-by-case basis. For example, the following Proposition provides an explicit formula for the variance [symbol] (\tilde{X}) in I-P-I Design 1 & 2.

### Proposition (Variance Inflation in I-P-I Design 1).

Assume that Fᵤ and Fᵥ are continuously differentiable on [symbol] , the support of U, V, and

$${lim }_{t \to ∞} {t}^{2} {F}_{x} ( t ) = {t}^{2} {F}_{v} ( t ) = 0 , {lim }_{t \to - ∞} {t}^{2} \{ 1 - {F}_{x} ( t ) \} = {t}^{2} \{ 1 - {F}_{u} ( t ) \} = 0$$

The \tilde{X} in (12) satisfies

$$𝕍 ( \tilde{X} ) - 𝕍 ( X ) = {\int }_{X} {F}_{x} ( u ) \frac{{\{ 1 - {F}_{u} ( u ) \}}^{2}}{{f}_{u} ( u )} du + {\int }_{X} \{ 1 - {F}_{x} ( v ) \} \frac{{\{ {F}_{v} ( v ) \}}^{2}}{{f}_{v} ( v )} dv \qquad ( 45 )$$

whenever the right hand side is well defined, for example when the following condition holds

$${lim }_{u \to - ∞} {F}_{x} ( u ) {e}^{- u / s} = 0 , {lim }_{u \to ∞} 1 - {F}_{x} ( v ) ) {e}^{v / s} = 0 \qquad ( 46 )$$

Example (Variance Estimation).

Even when Fₓ is unknown, it is possible to construct an estimator of [symbol] (X) depending on F_{u,v}. Suppose that Y˜N(μ, σ²) is Gaussian. Note that these two conditions hold for X being Gaussian. We obtain

$$𝕍 ( \tilde{X} ) = {σ}^{2} + {s}^{2} exp \{ - \frac{μ + a}{s} + \frac{{σ}^{2}}{2 {s}^{2}} \} + {s}^{2} exp \{ \frac{μ - a}{s} + \frac{{σ}^{2}}{2 {s}^{2}} \} \qquad ( 47 )$$

Note that [symbol] (\tilde{X})→ [symbol] (X) as a→∞, which matches the intuition. Let [symbol] _{N}(\tilde{X}) denote the sample variance of (\tilde{X}) calculated from \tilde{x}₁, . . . , \tilde{x}ₙ. Consider the equation of σ²:

$${σ}^{2} + {s}^{2} exp \{ - \frac{μ - a}{s} + \frac{{σ}^{2}}{2 {s}^{2}} \} + {s}^{2} exp \{ \frac{μ - a}{s} + \frac{{σ}^{2}}{2 {s}^{2}} \} - {𝕍}_{n} ( \tilde{X} ) = 0 \qquad ( 48 )$$

The above root exists and is unique if [symbol] _{N}(\tilde{X})>s² exp{(−μ+a)/s}+s² exp{(μ−a)/s}, since the left hand side is an increasing function of σ². This motivates the follow consistent estimator of μ, σ²:

$${\hat{μ}}_{n} ( {F}_{x} ) = {𝔼}_{n} ( \tilde{X} ) , {\hat{σ}}_{n}^{2} ( {F}_{x} ) = \{ \begin{matrix}the root of ( 29 ) & if the root exists ; \\ any positive value & otherwise\end{matrix}$$

A similar procedure may be applied to other interval mechanisms. For example, the above arguments apply to the I-I Design 1 since it is a special case of the I-P-I Design 1 when a=0. For another example, to estimate the variance σ² for I- . . . -I Design 2, equation 37 implies that the \hat{σ}ₙ²(Fₓ) in (49) is still consistent, except that Equation (48) needs to be replaced with

$${σ}^{2} + \frac{1}{m - 1} [ {s}^{2} exp \{ - \frac{μ}{s} + \frac{{σ}^{2}}{2 {s}^{2}} \} + {s}^{2} exp \{ \frac{μ}{s} + \frac{{σ}^{2}}{2 {s}^{2}} \} ] - {𝕍}_{n} ( \tilde{X} ) = 0 \qquad ( 50 )$$

Example (Covariance Estimation).

Suppose that [X₁, . . . , Xₚ] is a multivariate random variable whose covariance Σₓ is unknown and needs to be estimated. The covariance of each pair of variables, say X₁, X₂, satisfies

$${\sum }_{x , 12} = 𝔼 ( {X}_{1} {X}_{2} ) = 𝔼 \{ {X}_{1} 𝔼 ( {X}_{2} \vert {X}_{1} ) \} = 𝔼 \{ {X}_{1} 𝔼 ( {\tilde{X}}_{2} \vert {X}_{1} ) \} = 𝔼 \{ {X}_{1} {\tilde{X}}_{2} \} = 𝔼 \{ {\tilde{X}}_{2} 𝔼 ( {X}_{1} \vert {\tilde{X}}_{2} ) \} = 𝔼 \{ {\tilde{X}}_{2} 𝔼 ( {\tilde{X}}_{1} \vert {\tilde{X}}_{2} ) \} = 𝔼 \{ {\tilde{X}}_{1} {\tilde{X}}_{2} \} \qquad ( 51 )$$

Therefore, Σ_{x,12} may be estimated by the consistent estimator \hat{Σ}_{x,12}=n⁻Σᵢ₌₁ⁿ\tilde{X}_{1,i}\tilde{X}_{2,i}, where \tilde{X}_{j,i} is the surrogate value for Xⱼ computed from the ith observation (for j=1, 2). In the above derivation, we used [symbol] (X₁|\tilde{X}₂)= [symbol] (\tilde{X}₁|\tilde{X}₂). An implicit assumption for this to hold is that the interval mechanisms are independently applied to X₁ and X₂.

We may obtain

\hat{ρ}=\hat{Σ}_{x,12}/\sqrt{\hat{σ}ₙ²(Fₓ_{₁})·\hat{σ}ₙ²}(Fₓ_{₂}) (52)

as a content estimation of the correlation between X₁ and X₂.

Experiment 2 (Correlation Estimation).

In a simulation study, we let X₁, X₂ be bi-variate Gaussian with correlation ρ=0, 0.5, 0.9. We calculated the sample correlation using the aforementioned method and its standard error (from 100 replications) under two different interval mechanisms, for sample sizes n=100, 300, 500. The Mechanism 1 uses the I-P-I interval mechanism (Definition 5(b), Example 1 with s=1, a=1), and the privacy leakage is around 0.4. The Mechanism 2 uses the I- . . . -I mechanism with m=10, and the privacy leakage is around 0.7. The results are reported in Table 4.

TABLE 4
(Correlation estimation Experiment) Correlation estimation
from bi-variate interval-valued data, where the mean and standard
error from 50 independent replications are reported.

| | ρ = 0 | | ρ = 0.5 | | ρ = 0.9 | |
|---|---|---|---|---|---|---|
| n | 100 | 500 | 100 | 500 | 100 | 500 |
| Mechanism 1 | 0.09(0.05) | −0.02(0.02) | 0.47(0.04) | 0.49(0.02) | 0.94(0.04) | 0.92(0.02) |
| Mechanism 1 | −0.01(0.02) | 0.00(0.01) | 0.49(0.02) | 0.50(0.01) | 0.93(0.01) | 0.91(0.01) |

Use for More Complicated Learning Tasks.

In many learning problems to be elaborated in later sections, the solutions often reduce to the estimation of certain means or (co)variances. Many times, we can simply replace the unobserved X with \tilde{X}. We exemplify this through the following two estimation problems. In the rest of the paper, we consider the following default setup. We use the I-I Design 1 in (22) as the default option to construct \tilde{X} from privatized data of X. We generate U in the way described in (26), with F being a Logistic distribution with scaling factor s, and by default s=1. We will assume that the interval mechanism is independently applied to each scalar random variable. As before, we will use \tilde{X} to denote the D-transformed variable of the raw data X, so that it satisfies [symbol] (\tilde{X}|X, R)=X for any given raw data X and side information R (Corollary 1). Note that V(X^{˜}) usually depends on the distributions of anchor points U and raw data Y, and may or may not be finite. Though the existence of [symbol] (\tilde{X}) may be verified analytically, it can be difficult to verify without knowing the distribution of Y in practice. We will assume that \tilde{X} has a finite variance for technical convenience when performing variance and covariance estimation in later sections.

### Supervised Learning

### A. Linear Regression

Privatizing features X.

Suppose that the underlying data generating process is modeled by a linear regression model

Y=β^{T}X+ε (53)

where X∈ [symbol] ^{p} is a p-dimensional feature vector with zero mean and Σₓ as the covariance matrix, ε is a random noise with zero mean and bounded variance, and ε is independent with X. The unknown parameter is β∈ [symbol] ^{p}. Suppose that the observed data are realizations of (Y, Z_{X}), where Z_{X} is the interval-privatized data for X. We apply a D-transformation to Z_{X} to obtain \tilde{X}. It can be calculated that

[symbol]

(Y\tilde{X})= [symbol] {Y [symbol] (\tilde{X}|Y)}= [symbol] {Y [symbol] (X|Y)}= [symbol] (YX)= [symbol] (XX^{T}β)=Σₓβ (54)

Thus, a consistent estimator of β is

\hat{β}=Σₓ⁻¹ [symbol] ₙ(Y\tilde{X}) (55)

where [symbol] ₙ denotes the empirical expectation. Moreover, if Σₓ is unknown, it may be further estimated.

Privatizing Response Y.

In this scenario, Y is to be privatized. Similarly to (54), we have [symbol] (\tilde{Y}X)= [symbol] (YX)=Σₓβ, which leads to the estimator \hat{β}=Σ_{X}⁻¹ [symbol] _{M}(\tilde{Y}X). Moreover, suppose that both the response Y and features X are privatized. It holds that [symbol] (\tilde{W}\acute{X})=Σₓβ, and thus we may use

\hat{β}=Σₓ⁻¹ [symbol] ₙ(\tilde{Y}\tilde{X}) (56)

as an estimator

Proposition.

Assume that [symbol] (\tilde{X}) and [symbol] (Y) are finite, and data is generated from (53) with β=β_{*} and p a fixed integer. The \hat{β} in (56) is a consistent estimator of β. Moreover, we have [symbol] (β_{*}^{T}\tilde{X}−Y)=0, [symbol] β_{*}^{T}X(β_{*}^{T}\tilde{X}−Y)}−Y)=0, [symbol] β_{*}^{T}\tilde{X}⁽²⁾(β_{*}^{T}\tilde{X}−Y)}−Y)=0.

Regression Diagnostics.

The proposed D-transformation provides natural machinery to perform regression diagnostics, which were known to be challenging in the classical literature of survival analysis. In particular, we will propose the following way of performing residual analysis to visualize the adequacy of postulated regression models and the assumption of independent noise. Suppose that \hat{β} is an estimated regression coefficients under the postulated model using Y and \tilde{X}. Suppose that we fit the linear regression model (53) using realizations of [Y, \tilde{X}], and obtain \hat{β}. Then we may plot Ŷ−Y where \tilde{Y}=\hat{β}^{T}\tilde{X} (as the x-axis) against \hat{β}^{T}X (as the x-axis). If \hat{β}≈β_{*}, then we expect to see a null residual plot when the postulated model is valid. Nevertheless, \hat{β}^{T}X may not be known since X is unobserved. In practice, a data analyst may choose to query another interval-privatized data \tilde{X}⁽²⁾ from X, and use \hat{β}^{T}\tilde{X}⁽²⁾ as the x-axis. We do not use \hat{β}^{T}\tilde{X} because it is usually correlated with \tilde{Y}−Y.

### B. Empirical Risk Minimization

Suppose that we fit the following regression model

Y=f(x)+ε (57)

where f is an unknown regression function.

This model includes the model (53) as a special case. To address privatized Y, we may simply replace Y with its surrogate \tilde{Y}. This is because [symbol] (\tilde{Y}|X)= [symbol] (Y|X)=f(X), and thus the solution to

$$\hat{f} = {argmin}_{f ∈ ℱ} {\sum }_{i = 1}^{n} {( {\tilde{Y}}_{i} - f ( {\tilde{X}}_{i} ) )}^{2} \qquad ( 58 )$$

is a consistent estimator of f_{*} under mild conditions.)

To estimate the model in (57) with privatized X, we cannot apply a similar argument in (54) due to a lack of linear structure imposed on f. Alternatively, it is tempting to directly use [Y, \tilde{X}] to fit a nonlinear model by minimizing some loss within a function class F as in (58). Assume that the data are indeed generated from (37) with some underlying correct f_{*}∈F. The solution of (38) may not be consistent even in the linear regression case. This is conceptually related to the literature of regression attenuation, where regression slopes tend to shrink towards zero due to measurement error of covariates. For example, if one fits the simple linear regression Y=β₀+β₁X+ε using data X+η instead of X, where η is independent with X, the coefficient shrinks by a factor of [symbol] (X)/{ [symbol] (X)+ [symbol] (η)}. Obtaining a consistent estimation of nonlinear f under privatized X is, in general, a challenging problem. We recommend the following solution. Given labeled data [Yᵢ, Xᵢ] that may come from a regression or classification task, we estimate the unknown function f by solving the following empirical risk minimization problem

$${\hat{ℊ}}_{n} = arg {min}_{ℊϵℱ} {n}^{- 1} {\sum }_{i = 1}^{n} ℓ ( {y}_{i} , f ( {x}_{i} ) ) \qquad ( 59 )$$

where F is a regression function class and 1:X×Y→ [symbol] +∪{0} is a task-related loss function; we then use the rescaled function \hat{f}ₙ=λĝₙ to predict for future X, where

$$λ = {p}^{- 1} {\sum }_{j = 1}^{p} \frac{𝕍 ( {\tilde{X}}_{j} )}{𝕍 ( {X}_{j} )} \qquad ( 60 )$$

The above λ is motivated by the exact shrinkage factor in the simple linear regression case. Our numerical studies show that the above general method works reasonably well for nonlinear regression. The pseudocode of general supervised learning is summarized in Algorithm 2.

Algorithm 2 Supervised Learning with the D-transformation method

Input: Privatized responses zᵢ (from yᵢ ∈ [symbol] ) and privatized features [z_{i;j} : j = 1; : : : ; p]
(from xᵢ;1; : : : ; x_{i;p} ∈ X), where i = 1; : : : ; n denotes each observation, regression
function class [symbol] , loss function [symbol]
1: Apply the D-transformation to zᵢ to obtain \tilde{y}ᵢ, i = 1; : : : ; n
2: Apply the D-transformation to x_{i;j} to obtain \tilde{x}_{i,j} , j = 1; : : : ; p, i = 1;
: : : ; n
3: If a linear regression is used, obtain \hat{ƒ}ₙ based on (56)
4: Else, solve ĝₙ = ar g min_{f∈} [symbol] Σᵢ₌₁ⁿ [symbol] (\tilde{y}ᵢ,
ƒ(\tilde{x}_{i,1}, ..., \tilde{x}_{i,p})) ,
and let \hat{ƒ}ₙ = λĝₙ
Output: The estimated function \hat{ƒ}ₙ = χ → [symbol] , where λ is given in
(60)
5: For the future prediction, if the raw data x is given, we apply \hat{ƒ}ₙ to it; if only the
interval privatized data is given, we apply the
D-transformation to obtain \tilde{x}, and then apply \hat{ƒ}ₙ to its rescaled version (see Step 3).

Experiment

In an experiment, we simulated data from the following two data-generating models with n=1000, p=5. The data observed by the data collector/analyst is interval-valued data for each dimension of X using the I-P-I interval mechanism. In particular, the I-P-I Design 1, U, V Design 1, with s=a=1 (as described in Table II) is applied to each dimension of X. We also report the case when Y is not privatized and privatized (when the same privacy mechanism is applied to its standardization).

Model M1: a linear model Y=β_{T}X+ε, where β=[1, . . . , 1]^{T}∈ [symbol] p, X₁, . . . , Xₚ, ε˜N (0, 1) are independent. The signal-to-noise ratio (SNR), defined by [symbol] (Y|X)/ [symbol] (ε), is 5.
Model M2: a nonlinear model Y=10 sin(πX₁X₂)+20(X₃−0.5)²+10X₄+5X₅+ε, where X₁, . . . , Xₚ are independent and uniformly distributed on [0, 1], and ε˜N(0, 1) is the independent noise. This data is also known as the Friedmanl dataset, with SNR around 24.

For the data generated from M1, we fit it using the linear regression model in (53); for the data generated from M2, we fit it using the (nonlinear) gradient boosting regression (with depth 3, 100 boosting stages, and 0.1 learning rate) as well as the linear regression; The predictive performance are summarized in Table 5 below, where we compared three methods, including the proposed method in Algorithm 2, the mid-value method that simply uses the anchor points as a surrogate, namely

$${X}^{′} = X \cdot {Δ}_{{i}_{+}} + \{ {U}_{1} {Δ}_{1} + {U}_{m - 1} {Δ}_{m} + \frac{{U}_{k - 1} + {U}_{k}}{2} ( 1 - {Δ}_{1} - {Δ}_{m} ) \} \cdot ( 1 - {Δ}_{{i}_{+}} ) \qquad ( 61 )$$

where k is such that (Uₖ₋₁, Uₖ] contains X, and U, Δ are defined in Definition 3.

The performance as evaluated by L₁ and L₂ losses are reported in Table 5. The results show that the proposed method works reasonably well even if both X and Y are privatized, except in misspecified linear regression models (where a severe underfitting occurs). Moreover, interval-privatized Y tends to degrade performance compared with point-valued Y, which is conceivable.

It is worth noting that for I-P-I design, a natural alternative method is to only consider the point-valued data of X and omit all those involving intervals. Nevertheless, this is often not realistic for moderately large p. For instance, in our experiment, the probability of observing a point-valued X is at the order of 10-4 (by calculation). Thus, point values barely appeared in our replicated experiments (with a sample size of n=1000). Moreover, this method does not apply to many other designs that only involve intervals, and therefore we did not consider it in the experiments.

TABLE 5
Predictive performance of the proposed solution (‘Interval data’), the mid-value
method (‘Mid-value data’), and the oracle approach that uses the raw
data (‘Raw data’), for n = 1000 data generated from either M₁ or M₂,
and for linear regression and nonlinear regression methods. The perfomance
is evaluated using L₁and L₂ losses on 10⁴ simulated testing data,
averaged over 50 independent re plications (with standard errors).

| | | M₁, linear | | M₂, nonlinear | | M₂, linear | |
|---|---|---|---|---|---|---|---|
| | | model | | model | | model | |
| Privatized | Loss | X | X&Y | X | X&Y | X | X&Y |
| Interval | L₂ | 0.09(0.01) | 0.10(0.01) | 9.28(2.97) | 14.82(0.96) | 338.6(8.75) | 332.62(8.51) |
| data | L₁ | 0.23(0.01) | 0.24(0.01) | 2.20(0.17) | 2.83(0.07) | 15.82(0.12) | 15.72(0.13) |
| (proposed) | | | | | | | |
| Mid-Value | L₂ | 4.19(0.03) | 4.73(0.03) | 19.32(0.2) | 230.42(0.27) | 226.91(0.58) | 230.04(0.23) |
| data | L₁ | 1.63(0.01) | 1.74(0.01) | 3.53(0.02) | 14.42(0.01) | 14.41(0.01) | 14.41(0.01) |
| Raw data | L₂ | 0.00(0.00) | 0.00(0.00) | 1.21(0.01) | 1.23(0.02) | 216.48(0.14) | 216.29(0.14) |
| | L₁ | 0.05(0.00) | 0.05(0.00) | 0.85(0.01) | 0.85(0.01) | 14.42(0.0) | 14.41(0.01) |

C. Linear Discriminant Analysis with Privatized Features

As we commented in equation (59), the proposed method may be directly used for classification where interval-transformed values are fed into an empirical risk minimization objective with a suitably chosen loss function. In some widely used classification models such as linear discriminant analysis (LDA), quadratic discriminant analysis (QDA), and logistic regression, one may develop more specific solutions. We will take LDA as an example in this subsection. A similar argument applies to QDA.

In a general classification problem, the raw data are in the form of (Y, X), where Y∈{1, . . . , k} denote the class label and X∈ [symbol] ^{p} is the feature vector, and the learning goal is to predict the label Y for any given X. LDA assumes that the data generating process is

Y˜multinomial(q),X|(Y= [symbol] )˜ [symbol] ( [symbol] ,V), ∀ [symbol] =1, . . . ,k (62)

q=[q₁, . . . , qₖ], μ₁, . . . , μₖ, V are often estimated from training data. To minimize the Bayes risk, the prediction is obtained by the decision rule

$$\hat{Y} ( X ) = arg {max}_{ℓ} ℙ ( Y = ℓ \vert X ) = - \frac{1}{2} {( X - {μ}_{ℓ} )}^{T} {V}^{- 1} ( X - {μ}_{ℓ} \qquad ( 63 )$$

Suppose that the interval mechanism is applied to each dimension of X, and the observed data is Z_{X}. We may apply the D-transformation to obtain \tilde{X} from Z_{X}, and then estimate μ₁, . . . , μₖ, V using from \tilde{X}. The estimation procedure is the same as the existing one based on X except that we need to correct the diagonal elements of V. Nevertheless, in the presence of large dimensional X whose dimension p is comparable to sample size n, various numerical studies indicate that using \tilde{X} directly as if X is more stable than the method corrects V. A possible reason is that the inflated variance on V's diagonal enhances the numerical stability when computing the V⁻¹ in (63), in a way similar to the ridge penalization method.

Experiment.

We exemplify the application to LDA with the ‘phoneme speech recognition’ dataset [43], which contains 4509 samples of digitized speech for five phonemes: aa, ao, dcl, iy, and sh, each sample being a speech frame of 32-ms audio. For each speech frame, a log-periodogram of length 256 was computed and stored as the feature vector X. In other words, we have p=256, k=5, and n=4509. We also considered n=1000 by randomly sampling. We consider three I- . . . -I interval mechanisms which uses a) m=3 intervals, s=4 (the scale of Logistic anchor distributions), b) m=3 and s=1, and c) m=6, s=1 on the standardized data. The privacy coverages for three mechanisms are around 0.9, 0.6, 0.3, respectively. We compared three data-processing procedures for LDA: interval data handled by the proposed D-transformation, interval data handled by the mid-value method in Equation 61, and the using raw data. The performance, as summarized in Table 6, shows the proposed method is comparable to the oracle method using raw data, and it consistently outperforms the mid-value method. Moreover, it is interesting to see that the proposed method slightly outperforms the method based on the raw data in mechanisms (b) and (c), possibly because the inflated variance stabilizes the large matrix inverse.

TABLE 6
Classification accuracy using LDA under three interval
mechanism as evaluated under 5-fold cross validation

| | Mechanism (a) | | Mechanism (b) | | Mechanism (c) | |
|---|---|---|---|---|---|---|
| | n = 1000 | n = 4509 | n = 1000 | 4509 | n = 1000 | N = 4509 |
| Interval | 88.6(0.6) | 88.9(0.4) | 93.3(0.5) | 92.3(0.2) | 93.5(0.4) | 92.8(0.2) |
| data | | | | | | |
| Mid-Point | 78.9(1.1) | 79.4(0.6) | 89.3(0.8) | 86.7(0.4) | 92.9(0.3) | 92.6(0.3) |
| data | | | | | | |
| Raw data | 91.7(0.6) | 92.6(0.2) | 91.7(0.6) | 92.6(0.2) | 91.7(0.6) | 92.6(0.2) |

### Applications to Dimension Reduction

### A. Sufficient Dimension Reduction

For a continuous multivariate random variable (Y, X) where X∈ [symbol] ^{p} and Y∈ [symbol] , a subspace S′ is called the effective dimension reduction (EDR) space if Y is independent with X conditional on PSI X, where PSI denotes the projection matrix of St. Under mild conditions, the intersection of all the EDR spaces is again an EDR space, named the central space, and denoted by S. If the dimension of S is much smaller than p, it is possible to represent a predictive model of Y using only a small number of variables (which are linearly transformed from X). To exemplify how our proposed method may be used for sufficient dimension reduction, we will consider a particular method called Sliced Inverse Regression (SIR).

### Consider the Model

Y=f(β₁^{T}X, . . . ,β_{d}^{T}X,ε) (64)

where X follows a p-dimensional elliptical distribution with mean zero and covariance matrix Σₓ. The βᵢ's are unknown projection vectors, d is unknown but is assumed to be much smaller than p, and the error ε is independent of x and has mean 0.

Note that in general, the matrix B=[β₁, . . . , β_{d}]∈ [symbol] ^{prod} is not identifiable but the column span of B, Col(B), can be identifiable. The SIR method is based on the following key identity

Col(Λ)=ΣₓCol(B) (65)

which holds for e distributions of X. In particular, Given n i.i.d. samples [yᵢ, xᵢ], i=1, . . . , n, SIR first divides them into H slices according to the quantiles of Y at h/H, h=1, . . . , H. Let the sample mean of X in the h-th slice be \tilde{x}ₕ. Then Λ= [symbol] ( [symbol] (X|Y)) can be estimated by

$$\hat{Λ} = {H}^{- 1} {\sum }_{h = 1}^{H} {\overline{x}}_{h} {\overline{x}}_{h}^{T} \qquad ( 66 )$$

The SIR then estimates the central space Col(B) by Col(\hat{Σ}_{X}⁻¹\hat{Λ}_{D}), where \hat{Σ}ₓ is the empirical variance of X, and \hat{Λ}_{d} consists of the top d eigenvectors of \hat{Λ}.

Suppose that we apply the proposed D-transformation to interval-privatized X and obtain \tilde{X}. Since [symbol] (\tilde{X}|Y)= [symbol] (\tilde{X}|Y), we could use the same SIR procedure where we only replace the \tilde{x}ₕ in (44) with \tilde{x}ₕ, the sample mean of \tilde{X} in the h-th slice. Using a similar argument as was used in [45], [52], it can be proved under some regularity conditions that Col(\hat{B}) converges in probability to Col(B). It is interesting to study extensions of the above method to high-dimensional settings, using LASSO-type shrinkages (see [51] and the references therein).

Experiment.

We exemplify the SIR with interval data with n=1000, p=10, 50, and variance dimension models. We generate X, β₁, . . . β_{d}∈ [symbol] ^{p} and ε∈ [symbol] from independent and standard Gaussian. For d=1, we generated data from the models M₁, M₂, M₃, and M₄ under the general formulation (42):

$$Y = \frac{{μ}^{3}}{2} + ɛ , Y = sin ( µ ) \cdot exp ( µ ) + ɛ , Y = exp ( µ ) + ɛ , Y = exp ( µ + ɛ ) \qquad ( 67 )$$

respectively, where μ=β^{T}X. For d=2, the models we considered are

$$Y = {\vert \frac{{μ}_{2}}{4} + 2 \vert}^{3} \cdot sign ( {μ}_{1} ) + ɛ , Y = {μ}_{1} \cdot exp ( {μ}_{2} ) + ɛ , Y = {μ}_{1} \cdot exp ( {μ}_{2} + ɛ ) , Y = {μ}_{1} \cdot {( 2 + {μ}_{2} / 3 )}^{2} + ɛ \qquad ( 68 )$$

respectively, where μk=β_{K}^{t}X for k=1, 2. For each dataset, we compared the proposed SIR method using three mechanisms of interval data, as well as the original SIR method using raw data. The performance for d=1 and d=2 is summarized in Table 7 and Table 8, respectively.

Recall that the goal is to estimate Col(β), the space spanned by β. For performance evaluation, we considered two quantities: 1) the estimation error D(Col(\hat{β}), Col(β)), where D(S, S′) denotes the Frobenius norm of the difference between the projection matrices associated with these subspaces S, S′, and 2) the estimated intrinsic dimension \hat{d}, denoted by \hat{d}. The d was selected using Gap statistics, namely arg max_{i:1≤i≤H-1}(λᵢ−λᵢ₊ᵢ), where λ₁, . . . , λ_{H} are the singular values of X_{H} in descending order A benchmark value of D(S, S′) is d, which is achieved when the projection matrix of S′ is simply taken to be zero. Table 7 and Table 8 show that the proposed SIR method performs better as the privacy coverage decreases (or intervals are on average narrower). The performance under Mechanisms (b) and (c) is comparable to the oracle method using raw data. Under Mechanism (a), however, the inflated variances of \tilde{X} caused by less-informative intervals tend to favor too many intrinsic dimensions, which in turn degrades the performance. For example, for p=50, Mechanism (a) selects d\hat{ }s=9 in all four data cases. The number 9 is the maximum possible as we chose the number of slices to be H=10 in the experiments.

TABLE 7
Classification accuracy under three interval mechanisms as evaluated under 5-fold cross validation

| | | M₁ | | M₂ | | M₃ | | M₄ | |
|---|---|---|---|---|---|---|---|---|---|
| | | p = 10 | p = 50 | p = 10 | p = 50 | p = 10 | p = 50 | p = 10 | p = 50 |
| Mechanism | D(\hat{B}, B) | 0.61(0.02) | 2.96(0.00) | 0.91(0.05) | 0.75(0.04) | 0.75(0.04) | 2.98(0.00) | 0.67(0.03) | 2.97(0.00) |
| (a) | \hat{d} | 1.00(0.11) | 9.00(0.00) | 1.26(0.06) | 9.00(0.00) | 1.14(0.06) | 9.00(0.00) | 1.06(0.04) | 9.00(0.00) |
| Mechanism | D(\hat{B}, B) | 0.24(0.01) | 0.49(0.01) | 0.30(0.01) | 0.56(0.01) | 0.26(0.01) | 0.53(0.01) | 0.25(0.01) | 0.49(0.01) |
| (b) | \hat{d} | 1.00(0.00) | 1.00(0.00) | 1.00(0.00) | 1.00(0.00) | 1.00(0.00) | 1.00(0.00) | 1.00(0.00) | 1.00(0.00) |
| Mechanism | D(\hat{B}, B) | 0.18(0.01) | 0.41(0.01) | 0.22(0.01) | 0.47(0.01) | 0.19(0.01) | 0.45(0.01) | 0.19(0.01) | 0.41(0.01) |
| (c) | \hat{d} | 1.00(0.00) | 1.00(0.00) | 1.00(0.00) | 1.00(0.00) | 1.00(0.00) | 1.00(0.00) | 1.00(0.00) | 1.00(0.00) |
| Raw data | D(\hat{B}, B) | 0.14(0.00) | 0.31(0.01) | 0.17(0.01) | 0.38(0.00) | 0.14(0.01) | 0.36(0.00) | 0.14(0.00) | 0.32(0.00) |
| | \hat{d} | 1.00(0.00) | 1.00(0.00) | 1.00(0.00) | 1.00(0.00) | 1.00(0.00) | 1.00(0.00) | 1.00(0.00) | 1.00(0.00) |

TABLE 8
(Experiment 5) Classification accuracy under three interval mechanisms as evaluated under 5-fold cross validation

| | | M₁ | | M₂ | | M₃ | | M₄ | |
|---|---|---|---|---|---|---|---|---|---|
| | | p = 10 | p = 50 | p = 10 | p = 50 | p = 10 | p = 50 | p = 10 | p = 50 |
| Mechanism | D(\hat{B}, B) | 0.96(0.03) | 3.01(0.01) | 1.16(0.04) | 3.02(0.01) | 1.01(0.04) | 2.98(0.00) | 1.10(0.03) | 3.03(0.01) |
| (a) | \hat{d} | 1.68(0.08) | 9.00(0.00) | 1.98(0.18) | 9.00(0.00) | 20.8(0.14) | 9.00(0.00) | 1.56(0.09) | 9.00(0.00) |
| Mechanism | D(\hat{B}, B) | 0.35(0.01) | 1.00(0.06) | 0.44(0.02) | 1.12(0.08) | 0.35(0.01) | 0.79(0.01) | 0.45(0.03) | 1.30(0.10) |
| (b) | \hat{d} | 2.00(0.00) | 2.36(0.24) | 1.94(0.03) | 2.54(0.31) | 2.00(0.00) | 1.98(0.02) | 1.90(0.04) | 3.08(0.40) |
| Mechanism | D(\hat{B}, B) | 0.28(0.01) | 0.71(0.01) | 0.31(0.01) | 0.77(0.02) | 0.27(0.01) | 0.64(0.01) | 0.35(0.03) | 0.85(0.02) |
| (c) | \hat{d} | 2.00(0.00) | 1.00(0.00) | 2.00(0.00) | 1.90(0.00) | 2.00(0.00) | 2.00(0.00) | 1.92(0.04) | 1.76(0.00) |
| Raw data | D(\hat{B}, B) | 0.22(0.00) | 0.57(0.01) | 0.24(0.01) | 0.59(0.0) | 0.21(0.01) | 0.51(0.00) | 0.24(0.02) | 0.65(0.02) |
| | \hat{d} | 2.00(0.00) | 2.00(0.00) | 2.00(0.00) | 2.00(0.00) | 2.00(0.00) | 2.00(0.00) | 1.98(0.02) | 1.94(0.03) |

### B. Principal Component Analysis and Canonical Correlation Analysis

The principal components analysis (PCA) algorithm is a standard tool for identifying good low dimensional approximations to high-dimensional data. We will show that PCA can be used for dimension reduction and visualization of multidimensional interval-valued data. PCA estimates few principal axes in the feature space, representing the directions of maximum variances in the data. Suppose that we obtain an estimated covariance matrix \hat{Σ}_{X} for X. Let \hat{Σ}_{X}=ΩΛΩ^{T} be the orthogonalization of \hat{Σ}_{X}, where the diagonal matrix Λ is sorted in descending order. Let Ω_{d} denote the matrix that consists of the first d columns of Ω. The transformation T_{X}=Ω_{d}^{T}X maps each data of X∈ [symbol] ^{p} to a smaller dimensional vector in [symbol] ^{d}.

Unlike PCA, the Canonical Correlation Analysis (CCA) aims to quantify the associations between two sets of variables using a small number of linear combinations in each set. Suppose that the two datasets are represented by random variables X∈ [symbol] ^{p} and Y∈ [symbol] ^{q} whose joint distribution exists. CCA seeks vectors a∈ [symbol] ^{p} and b∈ [symbol] ^{p} that maximizes the correlation between a^{T}X and b^{T}Y, also named the first pair of canonical variables. Such a and b can be determined using the covariance matrix of [X^{T}, Y^{T}], and thus our method is readily available to obtain an estimate for a and b. As a result, we can measure and visualize the associations between two sets of interval-valued data.

Experiment.

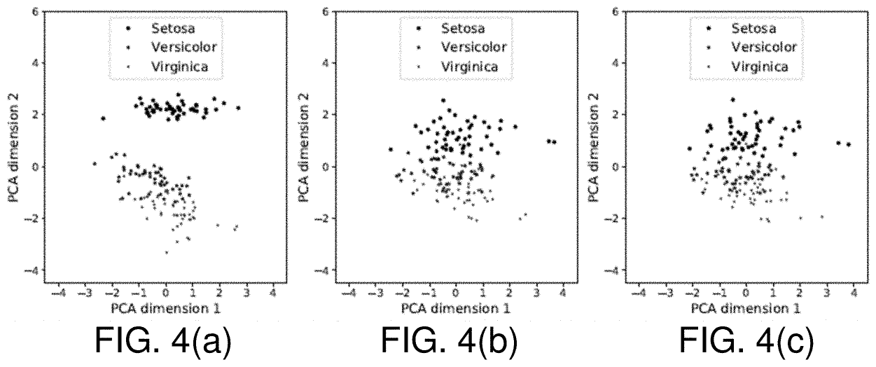

In an experiment of visualizing multidimensional intervals in 2D, we considered the Iris dataset that consists of 50 samples from each of three flower species of ‘setosa’, ‘virginica’ and ‘versicolor’, with an overall 150 samples. Four features were measured from each sample. We apply the Mechanism (c) on (standardized) X to obtain the intervals and then apply the D-transformation to obtain \tilde{X}. Different procedures of PCA were applied to visualize the projection onto two dimensions. FIG. 4(a) shows the result using the raw data; FIG. 4(b) shows the projection of the surrogate data \tilde{X} onto the same principal axes (which is not available in practice); FIG. 4(c) shows the projection of \tilde{X} onto the principal axes that were learned from \tilde{X}. For a better visibility, we standardized the transformed data in FIGS. 4(b) and 4(c). Note that the three point-clouds in FIG. 4(b) are less distinguishable due to the loss of information brought by intervals compared with those in FIG. 4(a). The comparison of FIG. 4(b) and FIG. 4(c) shows that the uncertainty brought by estimating the principal axes is not as significant as those brought by intervals. It indicates that the privacy-utility tradeoff is mostly at the privatization step.

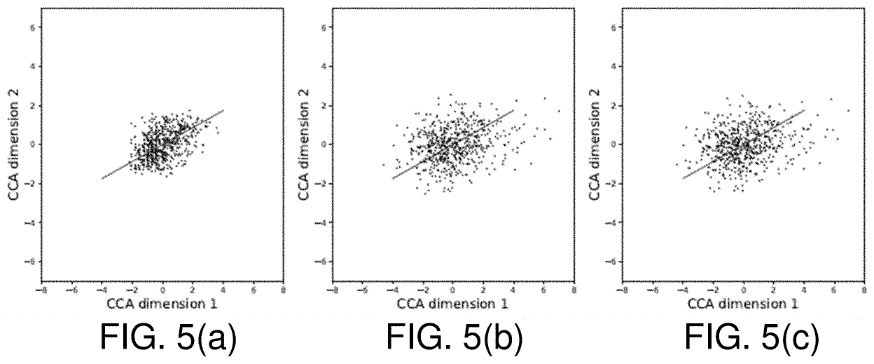

In another experiment, we studied the Mmreg data that consists of 600 college students and two sets of variables, including (psychological) ‘locus of control’, ‘self concept’, ‘motivation’, and (academic) ‘reading’, ‘writing’, ‘math’, ‘science’. CCA may be used to associate the psychological measures and academic achievement measures. We calculated a^{T}X and b^{T}Y in three settings similar to the PCA case and plotted them in FIGS. 5(a), 5(b) and 5(c). FIG. 5(a) shows the raw data, FIG. 5(b) shows X replaced with its surrogate \tilde{X}, and a,b are calculated from X, and FIG. 5(c) shows X replaced with its surrogate \tilde{X} and a,b are calculated from \tilde{X}. A fitted linear regression line is shown in each plot. As expected, the points in 5(b) and 5(c) are more scattered than those in 5(a). Also, the variation of the visualized data from estimating the CCA transformation using \tilde{X} is not as much as that from the data (namely \tilde{X}−X) itself.

### Other Experiments

### A. Causal Inference

We use the Infant Health and Development Program (IHDP) dataset, using Dowhy package. The data was from a study of infants from hospital discharge to 36 months between 1985 and 1988. Infants were randomized to the Intervention Group or the Follow-Up Group. The Intervention Group received home visits, attendance at a special child development center, and pediatric follow-up. The Follow-Up Group received only the pediatric follow-up component of the program. The treatment here is the intervention. The outcome was quantified through the combination of the mental, behavioral, and health statuses of infants. There are 25 variables such as the measures of cognitive development, behavioral status, health status, child's gender, race, etc. collected from both groups, which are possible confounders of the outcome and the intervention.

The goal is to estimate the average treatment effect on the outcome while accounting for the confounders (assuming the data are observational). To that end, we considered four methods, including the difference between the average outcome in the treatment group and the control group, the propensity score matching, the propensity score stratification, and the inverse probability weighting, where the last three methods employ Logistic regression. In this experiment, we only privatized the outcome data by using three I- . . . -I designs applied to each of the two practical scenarios: normalized data and unnormalized data. The estimated treatment effects are summarized in Table 9. As the data was collected through a randomized trial, we may estimate the causal effect by the difference of the average effect of the two groups without accounting for the confounders. The value estimated from the raw data is 4.02, which can be regarded as the oracle. The results indicate that the performance does not vary across different designs, and the estimates are close to the oracle. The performance in the first column exhibits larger standard errors because of its more information loss.

TABLE 9
Estimated average treatment effect from the IHDP Dataset, where we considered four methods
and three interval designs applied to either normalized or unnormalized raw data. Mean values
are calculated over 50 independent replications of (with standard errors in the parenthesis).
The casual effect estimated from the ‘Average difference’ method on raw data in 4.02.

| | Normalized data | | | Unnormalized data | | |
|---|---|---|---|---|---|---|
| Designs | m = 3, s = 4 | m = 3, s = 1 | m = 6, s = 1 | m = 3, s = 4 | m = 3, s = 1 | m = 6, s = 1 |
| Privacy | 14% | 39% | 61% | 23% | 25% | 42% |
| leakage | | | | | | |
| Average | 0.12(0.14) | 4.02(0.04) | 4.02(0.03) | 3.91(0.08) | 3.78(0.32) | 3.83(0.13) |
| difference | | | | | | |
| Propensity | 4.11(0.2) | 4.08(0.09) | 3.95(0.04) | 3.76(0.13) | 3.7(0.42) | 3.81(0.23) |
| score | | | | | | |
| matching | | | | | | |
| Propensity | 2.51(0.48) | 3.04(0.19) | 2.95(0.08) | 2.29(0.3) | 2.28(0.57) | 3.23(0.05) |
| score | | | | | | |
| stratification | | | | | | |
| Inverse | 3.52(0.15) | 3.42(0.05) | 3.36(0.03) | 3.25(0.08) | 3.14(0.26) | 3.15(0.13) |
| probability | | | | | | |
| weighting | | | | | | |

### B. CT-Aided Screening of COVID-19

Due to societal and ethical concerns, patients' private diagnostic data may not be publicly available. Nevertheless, it may help publish privatized data to solicit powerful data-driven diagnosis methods from the scientific community. For instance, during the outbreak time of Coronavirus Disease 2019 (COVID-19), a significant challenge in controlling the escalation of the disease is the shortage of test kits, which are mostly based on reverse transcription polymerase chain reaction (RT-PCR). Hospitals have been utilizing alternative diagnosis methods, including computed tomography (CT) scans, to facilitate the screening of COVID-19 patients. In this experiment, we apply interval privacy to CT image data and show its potential use for data-private image classification. We considered an open-sourced dataset ‘COVID-CT-Dataset’ consisting of CT images from patients infected or non infected by COVID-19 (labeled as ‘COVID’ and ‘Non-COVID’ respectively). The numbers in two classes are balanced, and among them, 425 images are for training and 203 for testing. Our goal is to first interval-privatize each pixel of the image, resulting in an image of pixel ranges. We apply the D-transformation to obtain the transformed images and train a classifier from it. We report the classification accuracy on the testing data. We note that the way we privatize an image is at a pixel-level and the anchor points are independent across pixels. The method could be replaced with more sophiscated methods, e.g., to use dependent anchor points, privatize preprocessed features from blocks of pixels, etc.

The model we used to train a classifier is a deep neural network named MobileNetV2. Since millions of pixels exist in each image and only a limited number of images, we use a transfer learning approach. In particular, we first store a pre-trained model using the Imagenet dataset, attach a two-layer feed-forward network of input dimension 1000, hidden dimension 20, and output dimension 2 that represents two classes, and re-trained the constructed neural network with our training images. During the training, we resized each image to have 224×224 pixels and used stochastic gradient descent with momentum 0.9 and initial learning rate 0.001, decayed by a factor of 0.1 every 7 epochs for an overall of 50 epochs. We considered the use of raw data (‘Raw’), I-P-I interval data generated from s=a=1 (‘M1’), I-I interval data generated from s=1 (‘M2’) and s=4 (‘M3’). The privacy leakages for the four scenarios are 100%, 43%, 24%, 7%, respectively. In the evaluation of testing performance, we consider two scenarios. In the first scenario, we use the original testing data. The numerical results, as summarized in the first three columns of Table 10, show that the performance of the proposed method is much better than that of random sampling, which is close to a random guess. The second scenario concerns the use of transformed testing data, parallel to the operation on the training data. Numerical results indicate that the performance in this scenario is better than the first scenario. This result indicates that bias induced by a shift of covariate distributions (between the training and testing) overweighs the change of learnability due to information loss. Interestingly, in both scenarios, the classification performance does not degrade as the privacy leakage reduces.

TABLE 10
(Subsection VII-B) Testing accuracy of classifying COVID and
Non-COVID CT-scanned images trained from interval-privatized
pixels, comparing the proposed method and the random sampling
method under four interval mechanisms. The first four columns
show the results based the original testing images, while the
last four columns show those based on transformed images (either
the proposed or the sampling approach. The benchmark accuracy
using raw training and testing data is 0.68.

| | Testing on the original | | | Testing the transformed | | |
|---|---|---|---|---|---|---|
| Mechanism | 1 | 2 | 3 | 1 | 2 | 3 |
| [symbol] -transformation | 0.61 | 0.59 | 0.60 | 0.71 | 0.70 | 0.67 |
| (proposed) | | | | | | |
| Random sampling | 0.48 | 0.54 | 0.55 | 0.54 | 0.56 | 0.52 |

### Categorical Data

Suppose that we have an urn that contains p=4 kinds of colored balls, say black, red, green, and blue. In an experiment, each of the n individuals draws a ball from this urn and then puts it back. The procedure generates n original data values. Due to privacy, the data collector asks each individual whether a (randomly-generated) subset (e.g., {red, blue}) includes the actual color. Assuming everyone's answer is honest, our observation consists of two-element sets, each containing an individual's actual color.

### II. Subset Privacy

Notation. We let [p]=[1, 2, . . . , p]. For a set a, let |a| denote its cardinality. Let a^{c} denote the complement of a subset a, and [symbol] an indicator function. Let log, ln, 0 log 0 denote the base-2 logarithm, natural logarithm, and zero, respectively. Let 1, Iₚ, diag(w), w^{T}, and w□u denote the all one vector, p×p identity matrix, diagonal matrix expanded by an vector w, the transpose of the vector w, and the outer product of w, u, respectively. We define M^{†} as the pseudo-inverse matrix of M, tr(M)=Σmᵢᵢ the trace of a matrix, and ∥w∥_{q}=(Σwᵢ^{q})^{1/q} the L_{q} norm of a vector w. We use [symbol] for expectation and [symbol] for probability. We write X⊥Y if X is independent with Y, and ∥/ if dependent.

### A. Formulation of Subset Privacy

We will focus on a scalar categorical random variable X, and then extend it to more general cases below.

Raw data: X∈[p] is assumed to be a random variable with distribution [symbol] (X=j)=wⱼ for j=1, 2, . . . , p.

We also write X˜p_{w}, w=(w₁, . . . , wₚ)^{T}, where p_{w} is the probability mass function (PMF) and p_{w}(j)=wⱼ.

Privatized data: A∈A is assumed to be a random variable whose joint distribution with X exists. Here, A={a:a∈[p]} denotes the set of all the subsets of [p].

Recall that we will collect A instead of X to infer population-level information while protecting each individual's privacy. We want |A|≥2 so that the true category cannot be immediately identified. Consequently, we need p≥3 for creating a non-trivial subset. For now, we assume that p≥4, and defer the special cases of p=2, 3 below. The case of p=1 is not interesting since the variable is deterministic. Also, it is appealing to design such A that does not immediately imply X. Ideally, the only information provided by A about X is the event X∈A, which is so-called non-informative property. This motivates the following definition.

Definition 7 (Subset Privacy):

A mechanism as described by a Markov chain X→A meets subset privacy, if |A|≥2 and for any x∈[p], a⊆[p],

$${ℙ}_{X \vert A} ( x \vert a ) = \frac{{p}_{w} ( x )}{{ℙ}_{w} ( x ∈ a )} {𝕝}_{\{ x ∈ a \}} ( x ) . \qquad ( 69 )$$

Next, we introduce a general mechanism to generate a Markov chain X→A satisfying the subset privacy.

Definition 8 (Conditional Mechanism):

A conditional mechanism is a Markov chain X→A whose transition law is determined by

P(A=a|X=j)=μₐ [symbol] _{j∈a}, ∀a⊆[p],j∈[p], (70)

where μₐ satisfies

$${\sum }_{aj ∈ a}^{ } {μ}_{a} = 1 , ∀ j ∈ [ p ] , and {μ}_{a} = 0 if \vert a \vert < 2. \qquad ( 71 )$$

Any specific realization {μₐ, a∈A} from a conditional mechanism is referred to as a conditional design. We will use {μₐ, a∈A} to represent a conditional design.

We will show that there exist infinitely many conditional designs (for p≥4). It can be verified that the conditional mechanism is the only mechanism to meet Definition 7. Nevertheless, it is nontrivial to find all the conditional designs that meet the constraints

$${\sum }_{aj ∈ a}^{ } {μ}_{a} = 1 , ∀ j ∈ [ p ] .$$

Additionally, such a mechanism requires the data collector to know the true value X to realize the design and generate A. As a result, the mechanism is often convenient only from the data publisher's perspective. Because of the above reasons, we will introduce a special conditional mechanism named independent mechanism that is easy to implement. The idea behind the independent mechanism is to generate a Markov chain X→A through another chain [X, Ã]→A, where Ã is independent with X, and A satisfies

A=Ã if X∈Ã, and A=Ã^{c} if X∉Ã (72)

In other words, the mechanism independently generates a subset Ã and then uses it or its complement as the subset observation A.

Definition 9 (Independent Mechanism):

An independent mechanism is a Markov chain X→A induced by another Markov chain [X, Ã]]→A, whose transition law is given by

Ã [symbol] X, [symbol] (Ã=ä)=v_{ä}, [symbol] (A=a|X=j,Ã=ä)=1_{j∈ä,a=ä}, ∀a,ä⊆[p],j∈[p] (73)

where vₐ, satisfies

$${\sum }_{a ∈ a}^{ } {v}_{a} = 1 , and {v}_{a} = 0 if \vert a \vert = 1 or \vert a \vert = p - 1. \qquad ( 74 )$$

We will use {vₐ, a∈A} to represent an independent mechanism throughout the paper. In practice, in order to avoid the trivial case that a=[p], we usually require v_{{[p]}}=v₍₀₎=0. It is conceivable that the final observation A will be non-informative, since A is constructed based on Ã that is independent with X. Technically, the transition law of X→A in Definition 9 can be characterized as P(A=a|X=j)=(vₐ+vₐ_{^{c}}) [symbol] _{j∈a} and thus every independent design {va, a∈A} leads to a conditional design {μₐ=vₐ+vₐ^{c}, a∈A}. In practice, the data collector only has to ask an individual whether the true value is in a subset Ã or not, hence the independent mechanism is most useful for data collection. Also, we note that there exist infinitely many independent designs that correspond to the same conditional design, but not every conditional design corresponds to an independent design.

As an example, a specific design under the independence mechanism is assigning all allowed subsets with the same probability.

Definition 10 (Uniform Independence Design):

An independence design {vₐ, a∈A} is uniform if

$${v}_{a} = \{ \begin{matrix}0 , & if \vert a \vert = 0 , 1 , p - 1 , p \\ \frac{1}{{2}^{P} - 2 p - 2} , & otherwise\end{matrix} \qquad ( 75 )$$

Before we conclude this subsection, we introduce another notation of a that will be frequently used in the remainder of the paper. We will represent a with 1ₐ, which is a vector in {0, 1}^{p}, with j-th coordinate one if j∈a and zero otherwise. Let 1_{A} be the random vector corresponding to 1ₐ. With the above notation, under a conditional design, the joint distribution of X, A is [symbol] (X=j, A=a)=wⱼμₐ [symbol] _{j∈a}, with marginal distribution [symbol] (A=a)=1ₐ^{T}wμₐ.

### B. Quantification of Privacy

In this subsection, we will quantify the amount of privacy for a conditional design or a particular user.

1) Threat model: A potential adversary can access subset observations {A₁, . . . , Aₙ}. We assume that the adversary does not know the identity of the individual associated with any subset A before observing the data. Its goal is to infer the individual's identity, the underlying value X, or both. The above setting is commonly seen in practice. For example, for data publishing, entities will often first anonymize the data by removing all identifiers. We allow the potential adversaries to know all or part of individuals' information.

2) Subset-size based privacy coverage and leakage: It is conceivable that a ‘larger’ subset A leads to more difficulty in guessing X since we would have less knowledge about X. Such knowledge means not only the cardinality of A but also the probability of X belonging to A. The above intuition motivates the following notion of privacy.

Definition 11 (Size Privacy):

The size of an individual subset a is defined as L(a)=P(X∈a)=1ₐ^{T}w. The size privacy coverage τ=(L(A))= [symbol] (1_{A}^{T}w), and the size privacy leakage is S=1−τ= [symbol] (1−1_{A}^{T}w).

In the above definition, we used the sum of probabilities of the categories observed in a subset to measure each individual's privacy. Size privacy coverage is the average subset size. The defined privacy coverage and leakage are naturally interpretable for the unique subset data format. For an individual being collected the subset a, the same subset may also be collected from L(a) portion of the population. The larger L(a) is, the more ambiguity of identifying a specific individual. The size of a subset a for the design is related to the underlying distribution w, which is usually unknown in practice. To actively control the lower bound of the privacy coverage, we will propose a modification of the subset privacy below.

Example (Obfuscated urn, continued): Assume that the underlying distribution is given by [symbol] (black)=0.01, [symbol] (red)=0.1, [symbol] (green)=0.2, and [symbol] (blue)=0.69. Suppose that we observe a={red, green, blue} from an individual. Then we know X is not black. However, this subset only eliminates a very small proportion of uncertainty. Knowing a will not significantly help us guess X. This is aligned with our defined subset size of 0.99, interpreted in the way that the individual datum is very secure given the observation.

In another case with a={black, red}, we know that a small-probability event occurs. In this case, knowing a leaks more information about X. Quantitatively, the subset size of a is 0.11, meaning a relatively higher privacy leakage. If we use a uniform design, the average subset size (or privacy coverage) for this example is about 0.684.

We note that subset privacy is a concept in a relative sense, comparing the information change before and after observing A. In a particular example, suppose that we know there is only one possible color, red. Then, even if

we observe {red, green}, the coverage is one because we do not leak any additional information. In this sense, it

is considered private.

3) Information-theoretic privacy coverage and leakage: From an information-theoretic perspective, a data privacy mechanism X→Y may be treated as a Markov chain, where the privatized data Y may take values in a general alphabet.

The subset privacy can also be quantified from the information-theoretic view. One natural idea is to measure the information contained in A about X using the mutual information.

Definition 12 (Mutual Information Privacy):

For a given design, the mutual information privacy leakage is

$$I ( X ; A ) = 𝔼log \frac{P ( X , A )}{P ( X ) P ( A )} ,$$

the privacy coverage is the conditional entropy H(X|A)= [symbol] log P(X|A).

Another natural idea is to measure the privacy leakage by the maximal probability (or ‘prediction risk’) to correctly guess the label X given A. Formally, let a random variable Y∈[p] be our guess for X. Then, X→A→Y forms a Markov Chain since Y only depends on A. The prediction risk is the largest probability [symbol] (X=Y) among all the conditional distributions [symbol] _{Y|A}.

Definition 13 (Prediction Privacy):

For a given design, the prediction privacy leakage and coverage are respectively

$$R ( X ; A ) = \text{?} ℙ ( X = Y ) , P ( X ; A ) = 1 - R ( X ; A ) . \\ \text{?} \text{indicates text missing or illegible when filed}$$

### C. Extension to Multiple Variables

In this subsection, we show that the one-variable case can be generalized to the multi-variable case. Suppose we have a d-dimensional random vector X=(X₁, . . . , X_{d})^{T}, each Xₖ being a discrete random variable of pₖ categories. The observation is A, a random variable whose value is a subset of all possible outcomes of X. We can construct a mapping X+X,

where X has

$$p = {\prod }_{i = 1}^{d} {p}_{i} \qquad ( 76 )$$

categories. In this way it degenerates to d=1 case.

A practical concern of constructing a mapping is a large sample space of the subset A, as | [symbol] |=2^{p} grows exponentially with d. To address this concern, we propose another way to deal with multiple variables. In particular, we restrict the form of observation A to the product of subsets corresponding to each Xₖ. In other words, A can be decomposed as the product of A=(A₁, . . . , A_{d}), where each Aₖ is a subset of possible outcomes of Xₖ. For implementation, we observe Aₖ from each Xₖ with a conditional mechanism, then put them together as A. As a result, the conditional mechanism for multiple variables becomes the following product mechanism.

Definition 14 (Product Mechanism):

A product mechanism is a Markov chain X→A whose transition law is determined by

$$ℙ ( A = \{ {a}_{1} , … , {a}_{d} \} \vert X = \{ {j}_{1} , … , {j}_{d} \} ) = {\prod }_{k = 1}^{d} \text{?} \text{?} , {∀}_{{a}_{k}} ⊆ \{ {p}_{k} \} , {j}_{k} ∈ [ {p}_{k} ] , k ∈ [ d ] \\ \text{?} \text{indicates text missing or illegible when filed} \qquad ( 77 )$$

where {μₐ_{ₖ}, aₖ⊆[pₖ]} is a conditional design for each k.

The advantage of using a product mechanism is that the sample space of A is a product space for every coordinate, with a cardinality 2^{Σ}^{ₖ}^{pk} instead of 2^{p}. It simplifies the construction of the conditional design for multiple variables and increases the parameter estimation efficiency and hypothesis testing power. As a particular case and interesting application, we will introduce the contingency table from two-variable subset data in Section IV and demonstrate the power of the product mechanism.

D. Extension to Two- or Three-Category Variables (p=2, 3)

In this subsection, we propose two solutions to address the case when p=2 or 3.

The first solution is by combining every two variables with less than four categories into one variable. For example, suppose we have two binary variables, say gender (male, female) and income (low, high). We represent them as a new variable with four categories and apply subset privacy based on this new variable. The inference of each variable is often straightforward from the inference of the combined variable. For example, the probability of observing one category is implied by the marginal distribution. The above method can be directly applied to any even number of variables. If we have an odd number of variables with less than four categories, a solution is to combine it with an artificial variable. In a practical data collection system, the above technique is easy to implement. Specifically, the data holder (who owns the private data) and the data collector may use an open-sourced program to generate a random number as an artificial variable.

An alternative method is to introduce dummy categories to the data, which is elaborated below.

### Parameter Estimation for Subset Data

In this section, we provide methods to estimate the population distribution w for a single variable X. Recall that the observed data (to the data collector/analyst) are n subsets A₁, . . . , Aₙ generated from some design {μₐ, ∀a∈ [symbol] } and i.i.d. original data X₁, . . . , Xₙ.

### A. MLE and Theoretical Properties

A standard way to estimate w is using the maximum likelihood estimator (MLE). Here we discuss the model identifiability, consistency, and asymptotic normality of MLE. Note that

$$w ∈ 𝒦 = \{ w : 0 \leq {w}_{i} \leq 1 {\sum }_{i = 1}^{p} {w}_{i} = 1 \} \qquad ( 78 )$$

has only p−1 degrees of freedom. We reparameterize the parameter space with

$$Θ = \{ θ : {θ}_{i} = {w}_{i} , 0 \leq {θ}_{i} \leq 1 , i = 1 , … , p - 1 ; {\sum }_{i = 1}^{n - 1} {θ}_{i} \leq 1 \} \qquad ( 79 )$$

Hence, we have w=α+Bθ, where α=(0, . . . , 0, 1)^{T}, B=(Iₚ₋₁,−1)^{T}.

Let xᵢ, aᵢ be n i.i.d. realizations of X, A. The log-likelihood function is

$${l}_{n} ( θ ) {=}^{Δ} {l}_{n} ( w ) = {\sum }_{i = 1}^{n} ln {1}_{{a}_{i}}^{T} ( α + B θ ) \qquad ( 80 )$$

Since there is a one-to-one mapping between w and θ, with a slight abuse of notation, we will also write the log-likelihood function as

$${l}_{n} ( w ) = ln ℙ ( {A}_{i} = {a}_{i} , i = 1 , 2 , … , n ) = {\sum }_{i = 1}^{n} ln {1}_{{a}_{i}}^{T} w \qquad ( 81 )$$

(up to a constant that does not depend on w). As we will discuss, Eq. (81) is more convenient for optimization, while Eq. (80) is suitable for theoretical analysis.

First, we provide a sufficient and necessary condition to guarantee the model identifiability.

Assumption 1 (Identifiability): If for all a with μₐ>0, 1ₐ^{T}Bu=0 holds, then u=0.

Theorem: A subset privacy model X→A is identifiable if and only if Assumption 1 holds. Moreover, for an independent mechanism, Assumption 1 is equivalent to the following: if for all a with μₐ>0, 1ₐ^{T}u=0 holds, then u=0.

The following assumption is sufficient to guarantee the uniqueness of the MLE.

Assumption 2 (Uniqueness of MLE): Matrix RB is full-rank, where R=(1ₐ_{₁}, . . . , 1ₐ_{ₙ})^{T}.

Note that if Assumption 1 holds, then Assumption 2 also holds with high probability, while Assumption 2 implies Assumption 1. To show the normality of MLE, we need a regularity assumption below.

Assumption 3 (Bound on log density): We assume there is a positive constant

$$c , s . t . {min}_{i , j ∈ [ p ]} ( {w}_{i} + {w}_{i} ) > c \qquad ( 82 )$$

Theorem (Consistency): Under Assumption 1, the MLE satisfies \hat{θ}ₙ→θ a. s. as n→∞. As a consequence, ŵₙ→w a. s. as n→∞.

Theorem (Asymptotic normality): Under Assumptions 1 and 3, the MLE satisfies \sqrt{n}(\hat{θ}ₙ−θ)→N(0, I(θ)⁻¹) in distribution. Hence \sqrt{n}(ŵₙ−w)→N(0, BI(θ)⁻¹B^{T}) in distribution, where I(θ) is the Fisher information matrix.

Next, we briefly introduce two algorithms to compute the MLE. It can be verified that Iₙ(w) is concave, and thus we need to solve the convex optimization problem

$${max}_{w ∈ 𝒦} {l}_{n} ( w ) \qquad ( 83 )$$

where [symbol] is the feasible range of w introduced at the beginning of this subsection.

A general algorithm to find an approximation of MLE is the expectation-maximization (EM) algorithm, where we treat X as missing. Applying the EM algorithm to Eq. (81), we can derive the iterative updating formula as wⱼ^{(m+1)}=n⁻¹Σᵢ₌₁ⁿ [symbol] ₘ(Xᵢ=j|aᵢ), where [symbol] ₘ(Xᵢ=j|aᵢ)=wⱼ^{(m)}1ₐ_{ᵢ}_{,j}/(1ₐ_{ᵢ}^{T}w^{(m)}) is the conditional probability under w^{(m)} at the m-th iteration.

### B. MoM and Theoretical Properties

Calculating the MLE is often computationally expensive, as there is no closed-form solution. Even with the approximation method like the EM algorithm, it still needs many iterations to converge. When the design is known, we propose a much faster estimator using the method of moments (MoM) and prove its consistency and asymptotic normality.

We introduce a coefficient matrix Q=(qᵢⱼ), qᵢⱼ=Σ_{i,jϵa}μₐ, ∀i,j∈[p], with the i-th row denoted as qᵢ. Note that for the k-th coordinate of a random vector 1_{A}=(1_{A,1}, . . . , 1_{A,p}), the first order moment

$${γ}_{k} {=}^{Δ} 𝔼 ( {1}_{A , k} ) = \text{?} ( {w}_{j} \text{?} {μ}_{0} ) = \text{?} w \\ \text{?} \text{indicates text missing or illegible when filed} \qquad ( 84 )$$

Hence, γ [symbol] (γ₁, . . . , γₚ)^{T}=Qw establishes the relationship between the first order moment of 1_{A} and population w. The empirical first order moment \hat{γ}=n⁻¹Σᵢ₌₁ⁿ1ₐ_{ᵢ} is the sample mean of 1_{A}. The above motivates the following moment-based estimator

Qŵ=\hat{γ} (85)

Assumption 1 ensures that Q is positive definite, so ŵ=Q⁻¹\hat{γ}. We introduce

$$C = Cox ( A ) = H - {γγ}^{T} , where H = ( {h}_{ij} ) , \text{?} = \text{?} , {h}_{ij} = {\sum }_{k = 1}^{p} ( {w}_{k} \text{?} \text{?} ) \\ \text{?} \text{indicates text missing or illegible when filed} \qquad ( 86 )$$

Then, as a direct application of the central limit theorem, we have that the MoM estimator defined in Eq. (85) satisfies \sqrt{n}(ŵ−w)→N(0,Q⁻¹CQ⁻¹) in distribution.

In particular, for the uniform design, there is a much simpler form. We have

$$\begin{matrix}{q}_{ij} = {r}_{p}^{- 1} , {r}_{p} {=}^{Δ} \frac{{2}^{p - 1} - p - 1}{{2}^{p - 2} - p + 1} , ∀ i \neq j , & ( 87 ) \\ therefore & \\ {\hat{w}}_{i} + {\sum }_{j \neq i} \frac{{\hat{w}}_{j}}{{r}_{p}} = {\hat{γ}}_{i} , or equivalently , \hat{w} = \frac{{r}_{p} \hat{γ} - {1}_{p}}{{r}_{p} - 1} & ( 88 )\end{matrix}$$

The equivalence is due to Σᵢŵᵢ=1

### C. One-Step Estimator Based on MoM

Based on the previous MoM estimator, which has a n^{-1/2} rate of convergence, we can further construct an asymptotically efficient estimator (just like the MLE) using the following one-step update.

\hat{θ}ₒₙₑ=\hat{θ}_{MoM}+∇²lₙ(\hat{θ}_{MoM})⁻¹∇lₙ(\hat{θ}_{MoM}), \hat{ω}ₒₙₑ=α+B\hat{θ}ₒₙₑ(7) (89)

where ∇² is the Hessian operator and ∇ is the gradient operator.

Under Assumptions 1 and 3, the one step estimator defined in Eq. (89) has the same asymptotic distribution as MLE.

### D. Extension to High-Dimensional Case

We show that when p grows with n, the MoM estimator is also consistent under some conditions.

Let MoM estimator be ŵ. If we use uniform design, then (p² ln p)/n→0 guarantees that ∥ŵ−w∥₁→0 in probability as n→∞. Also, with uniform design, p/n→0 guarantees that

∥ŵ−w∥₂→0 in probability as n→∞. Also, it can be proved using the Berry-Esseen Theorem that each coordinate of the MoM estimator is asymptotically normal under the uniform design, even when p>n.

### Contingency Table for Subset Data

As we mentioned above, the product mechanism is more suitable for multi-variable cases. In this section, we study the two-variable case by introducing a contingency table for subset data and then proposing methods for independence tests.

### A. Formulation

Suppose that we have two random variables X˜p_{wX}, Y˜pwY with wₓ∈ [symbol] ^{p}w^{Y}∈ [symbol] ^{q}, and the joint distribution [symbol] (X=x, Y=y)=w_{xy}, denoted by (X, Y)˜p_{wx} with W∈ [symbol] ^{pxq}. By the Definition 8 of product design, if we let both X→A and Y→B be conditional designs, then (X, Y)→(A, B) is a product design. Let {μₐ^{A}, ∀a∈A}, {μ_{b}^{B}, ∀b∈B} denote two conditional designs and s=|A|, r=|B| denote the cardinalities of possible outcomes. A typical s is much larger than p, and it is at most 2^{p}−p−2.

The observations under this setting are n i.i.d. pairs of Aᵢ, Bᵢ. Thus, it is natural to consider a two-way contingency table for A and B. In particular, the table N=({n_{ab}})_{s×r}, where each n_{ab} is the number of observations satisfying A=a, B=b.

### B. Independence Test

We study how to perform independence testing between X and Y based on the subset-valued contingency table N. Our null hypothesis is H₀:X [symbol] Y against the alternative H₁:X [symbol] Y. It can be verified that the joint and marginal distributions for A, B are

[symbol]

(A=a,B=b)=pₐ^{A}μ_{b}^{B}1ₐ^{T}W1_{b}, P(A=a)=μₐ^{A}1ₐ^{T}wx, P(B=b)=μ_{b}^{B}1_{b}^{T}ω_{Y}. (90)

Hence, the above hypothesis is equivalent to H₀:A [symbol] B against H₁:A [symbol] B. Based on this equivalence, we develop four tests below and numerically compare.

The methods are based on the estimation of distributions. With the contingency table, we can consistently estimate the joint distribution W using any of the methods mentioned above with a subtle modification. Let Ŵ, ω_{X}, ω_{Y} be the estimated parameters. We then estimate the distributions of A, B with

[symbol]

(A=a,B=b)=μₐ^{A}μ_{b}^{B}1ₐ^{T}Ŵ1_{b}, [symbol] (A=a)=μₐ^{A}1ₐ^{T}ω_{X}, [symbol] (B=b)=μ_{b}^{B}1_{b}^{T}\hat{ω}_{Y} (91)

1) Pearson's Chi-square test: The classical Pearson's Chi-square test statistics in our context is

T_{P}=Σ_{a,b}(n_{ab}−ϵ_{ab})²/ϵ_{ab}, where ϵ_{ab}=μ [symbol] (A=a) [symbol] (B=b) (92)

is the expected number of observations under the null hypothesis. Under the null hypothesis, T_{P} asymptotically converges to xₛᵣ², as n→∞. A common rule (and also our experiments) suggest using Pearson's Chi-square test only when all n_{ab}≥5.

2) Likelihood ratio test (LRT): Recall that the joint distribution of A, B is decided by W. The LRT here is based on the estimation of W and w_{X}, w_{Y}. In other words, the null is H₀: W=w_{X}⊙w_{Y} against H1:W represents a free discrete distribution. The test statistic is

$${T}_{L} = 2 \text{?} \text{?} ln \frac{\text{?} \hat{W} {1}_{b}}{\text{?} {\hat{w}}_{X} {\hat{w}}_{Y}^{T} \text{?}} . \\ \text{?} \text{indicates text missing or illegible when filed} \qquad ( 93 )$$

Under the null hypothesis, T_{L} converges to X²_{(p-1)(q-1)} in distribution as n→∞. Hence, the limiting distribution has a smaller degree of freedom compared with T_{P}.

3) Approximated LRT: From experimental results of parameter estimation methods discussed below, we find that the MoM estimator is significantly faster than other estimators but with similar accuracy. This motivates us to replace the MLE with MoM when evaluating the LRT. This leads to a test statistic the same as Eq. (93), except that the distribution parameters are estimated by MoM. Though the above test is to approximate the LRT, we experimentally find that the statistical power does not degrade.

4) Bonferroni correction: Instead of testing H₀:A [symbol] B, we simultaneously test the independence for each pair of coordinates of 1_{A}=(1_{A,1}, . . . , 1_{A,p})^{T}, (1_{B,1}, . . . , 1_{B,q})^{T} with a Bonferroni correction. In other words, we test

H₀:1_{A,x} [symbol] 1_{B,y}, ∀x=1, . . . ,p, y=1 . . . ,q. (94)

It proceeds as follows. For each x=1, . . . , p, y=1, . . . , q, we use the Pearson's Chi-square to calculate a p-value p_{xy} for H₀:¹^{_{A,x}} [symbol] 1_{B,y}. The corresponding aggregated contingency table has the form in Table 11. With a significance level a, we reject the null hypothesis if

$$\text{?} \text{?} < a / pq . \\ \text{?} \text{indicates text missing or illegible when filed} \qquad ( 95 )$$

TABLE 11
Aggregated Contingency Table

| | 1_{B}^{(y)} | |
|---|---|---|
| 1_{A}^{(x)} | 1 | 0 |
| 1 | ${\sum }_{a , b : x ∈ a , y ∈ b} {n}_{ab}$ | ${\sum }_{a , b : x ∈ a , y ∉ b} {n}_{ab}$ |
| 0 | ${\sum }_{a , b : x ∉ a , y ∈ b} {n}_{ab}$ | ${\sum }_{a , b : x ∉ a , y ∉ b} {n}_{ab}$ |

### Experimental Study on the Adult Dataset

In this section, we provide a real-data example to demonstrate the subset privacy and developed methods. We use the ‘Adult’ (also known as ‘Census Income’) dataset, which Barry Becker extracted from the 1994 Census database. The dataset contains N=32561 observations with 14 attributes. Among those attributes, race, gender, and income are of particular interest.

### A. Distribution of Race

There are five categories of race. The numerical labels and population distribution w are summarized in Table 12. Sometimes, race is considered as sensitive information, and it can be protected by subset privacy. Here, we show that our method provides desirable privacy, and it is efficient to estimate the population distribution.

TABLE 12
Population Distribution and Labels of Race

| Numerical label | Race category | w |
|---|---|---|
| 0 | Amer-Indian-Eskimo | 0.009551 |
| 1 | Asian-Pac-Islander | 0.031909 |
| 2 | Black | 0.095943 |
| 3 | Other | 0.008323 |
| 4 | White | 0.854274 |

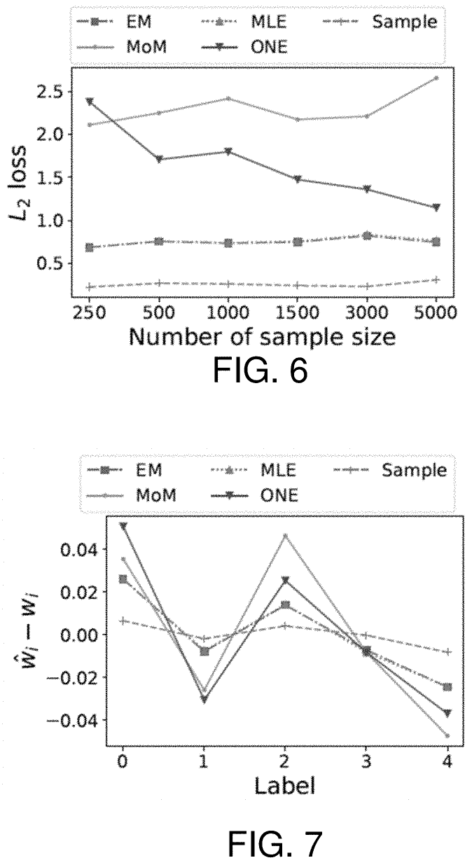

In the experiments, we randomly draw n samples from the original dataset in each replication. We draw subset observations based on the uniform design and estimate \hat{ω}. To stabilize the estimation, we replicate k=100 times and record the average scaled L₂ loss n∥\hat{ω}−ω∥₂². Its expectation is expected to converge to a constant as n→∞ for the proposed methods. We implement and compare the estimators above, including the MLE estimated by the EM algorithm (‘EM’), the MLE solved by a general-purpose optimization package CVXPY (‘MLE’), the moment-based estimator (‘MoM’), and the one-step estimator derived from MoM (′ONE). The additional line named ‘Sample’ is calculated from the original non-private data. The results for different values of n are summarized in FIG. 6. We also visualize the difference between estimates and ‘true’ parameters calculated from the whole dataset (in hindsight) in one replication (FIG. 7). From the results in FIG. 6, the n^{-1/2} rate of convergence holds even for a relatively small sample size. Also, the L₂ loss of MLE is about four times the loss of ‘Sample’, indicating that we need to double the sample size to obtain an error rate comparable with that of non-privatized data. Next, we will show the amount of privacy in the privacy mechanism.

### B. Amount of Privacy

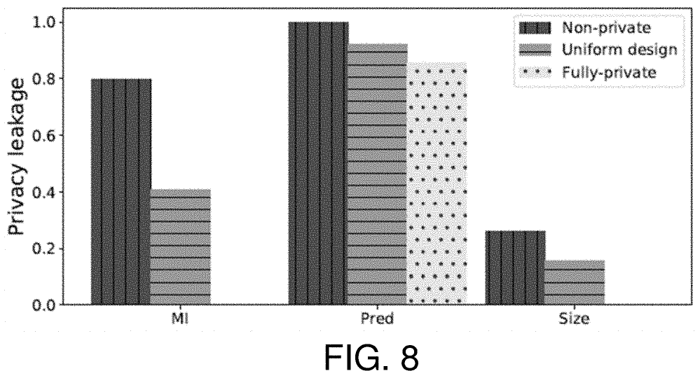

We calculate the privacy leakage for three designs using the three ways introduced in Subsection II-B. The three designs include the non-private design (A={X}), uniform design, and fully-private design (A=range(X)). The results are shown in FIG. 8.

As we expect, the privacy leakage of the uniform design is within the range of no privacy and full privacy. Mutual information privacy leakage is half the maximum leakage, meaning that the information about X contained in subset observations is one bit (either in or not in the subset). Size privacy leakage decreases from 0.25 to 0.15 after the use of uniform design. The interpretation is that we can eliminate 0.25 probability by observing the non-private data X on average, while we can only eliminate 0.15 from the private data A. Prediction privacy leakage decreases from 1 to 0.9, meaning that the probability we correctly guess the label is 0.9 from the uniform design. Without any privatization, we immediately know the true label, so the leakage is 1. One may worry that 0.9 represents a considerable leakage. However, we note that it needs to be compared with the minimum leakage. If we do not know any knowledge about X, then the optimal strategy is guessing the most likely category, which is ‘white’ in this case, with the average accuracy as 0.85.

In the above results, the measurement of privacy is averaged over the population. Recall that the size and prediction privacy can be applied to evaluate each individual's privacy as well. We illustrate the idea below.

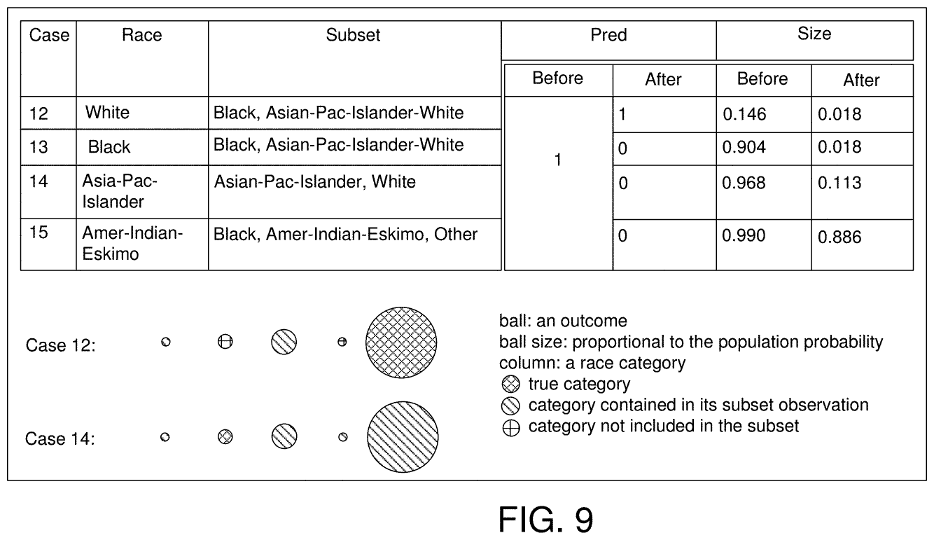

FIG. 9 shows a realization of the subset-private data of four observations from Case 12 to 15. We examine Case 12 and 14 in particular. The race of Case 12 is white, and the observed subset consists of black, white, and Asian. The optimal prediction is the category with the largest estimated probability (white, 0.854).

Because the true category coincides with the most likely one, the prediction leakage is one despite the privatization. The above scenario will change for Case 14, whose category is Asian-Pac-Islander. The subset observation includes white, so the optimal guess is still white, and an adversary will not coincidentally recover the true label. Moreover, a large amount of uncertainty is brought in because of the inclusion of white in the subset. The subset size leakage decreases significantly from 0.97 to 0.11 (compare the ball size of gray plus cyan and gray solely).

In conclusion, subset privacy protects the privacy of rare categories much better than the frequent categories at the individual level, which is an attractive property in real-world applications.

### C. Independence Tests of Gender and Income

The last application is to test the independence of gender and income under subset privacy. The null hypothesis is that they are independent. The contingency table from the whole non-private dataset is presented in Table III. Pearson's Chi-square test has a p-value close to zero, indicating that the two variables are effectively dependent at the population level. In the experiment, we take the dependence between gender and income as the ground truth.

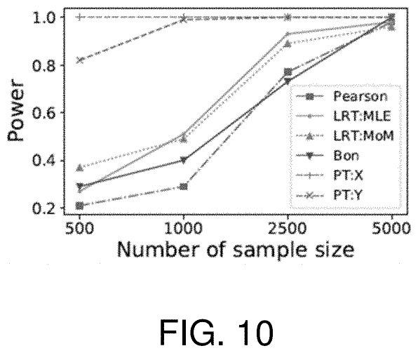

We will show the power of our tests while controlling the probability of type I error to be 5%. Specifically, we consider the Pearson's Chi-square test (‘Pearson’), likelihood ratio test designed for subset privacy (‘LRT:MLE’), likelihood ratio test with the MLE approximated by MoM (‘LRT:MoM’), Bonferroni correction-based test (‘Bon’). The subset data are generated as follows. First, since both gender and income are binary variables, after sampling n observations from the original dataset, we apply ‘p=2’-uniform design introduced in Subsection II-D to sample subsets from the Markov chain X→Y→A. Then, we perform all four tests based on subset observations. For comparison purposes, we also apply Pearson's Chi-square test to the non-private samples X and intermediate data Y, denoted by ‘PT:X’ and ‘PT:Y’, respectively. We independently replicate the above procedure k times, and each time we calculate the p-value and power for each test. The results are summarized in FIG. 10.

We note that the transformation from the original data X to intermediate data Y loses some information, and the subset sampling further loses information. FIG. 5 also implies that the sample size of subset observations needs to be four times that of data Y to achieve the same power. When the sample size is sufficiently large, all the methods can identify the dependence between gender and income. Overall, the LRT:MLE and LRT:MoM are better than other tests.

In the following, we highlight some subtle aspects of subset privacy and elaborate on its connections with (local) differential privacy.
1) The main advantages of subset privacy. The subset privacy offers the following practical benefits. First, it is easy to implement since its data collection procedure is naturally compatible with the existing survey-based collection methods. Second, it is user-friendly as individuals will only need to select from randomly-generated subset choices (e.g., through an open-source interface). Third, the collected message will obfuscate but not distort the original message, which can be extremely helpful in application domains that require authentic information (e.g., in the census). The above features distinguish subset privacy with (local) differential privacy and its variants.
2) Rigorous privacy guarantee. We will extend the aforementioned subset mechanisms to actively control size privacy at an individual level in Appendix II. It allows us to have a user-chosen lower bound of the size privacy regardless of the raw data. On the other hand, the subset privacy can be implemented in a population-independent manner, as the independent mechanism does not rely on the knowledge of the underlying data distribution. As a result, both the implementation and the coverage guarantee of subset privacy do NOT depend on the population distribution. This favorable property is also shared by differential privacy.

### Control of Privacy Coverage

In this section, we propose a modification of subset privacy, which enables us to control the privacy coverage. In other words, we can set an arbitrary lower bound (within [0, ½)) for the size privacy coverage.

We consider one-dimensional variable X∈ [symbol] ^{p} for brevity. The technique can be extended to the multi-dimensional case using the product design. We further consider the independent design {vₐ, a∈ [symbol] } with vₐ=vₐ_{^{c}}. For example, we may use a uniform design. The main idea is enlarging the domain of X from [p] to [p+2], while the last two categories are dummy or artificial categories. Then, we can generate dummy users with dummy categories. We also modify the independent design to ensure that the subset always contains one of the dummy categories. In this way, given a subset, an adversary can never tell whether it comes from a dummy or true user. We can control the ratio of dummy categories and thus the privacy coverage. The technical details are described below.

For a parameter 0<α<½ that gives the lower bound of the privacy coverage, we normalize the population distribution by \hat{ω}ⱼ=(1−2α)ωⱼ; j∈[p] and ωⱼ=α, j=p+1, p+2. Since the probability of a dummy category is at least a, and a subset must contain one of them, the size coverage is lower bounded by α. Accordingly, we state the following new subset-generating mechanism. If X is a true user (X∈[p]), then we draw a subset A⊂[p], X∈A by using the original design {vₐ, a∈A}. Then, we add one of the dummy categories to A with equal probability to produce the final output subset Â. If X is dummy, we draw A\tilde{ } from {vₐ, a∈A}, and Â=Â∪X. It can be seen that this procedure defines a new conditional design on the enlarged data domain [p+2]. Hence, we can apply all the developed methods to analyze the enlarged subset Â.

In summary, in addition to collecting the data from n users, we also simulate 2 an dummy users, each associated with a dummy category. Then, the collection system creates subsets from the induced design stated above. As long as a is revealed, the inference of true users' population information can be derived. Such modification ensures minimum size privacy to be a, retaining the virtue of faithfulness. Users only have to answer a relatively non-sensitive question of whether the true value is contained in a subset with a guaranteed privacy coverage.

### Two- or Three-Category Variables

Using a similar technique proposed above, we introduce another way to address two- or three-category variables. We only have to allow the independent design to sample subsets A such that |A|=1 or |A|=p−1. For instance, when p=2, if X∈[p], then Â={X, 3} or Â={X, 4} with equal probability; if X∉[p], then Â={X, 1} or Â={X, 2} with equal probability.

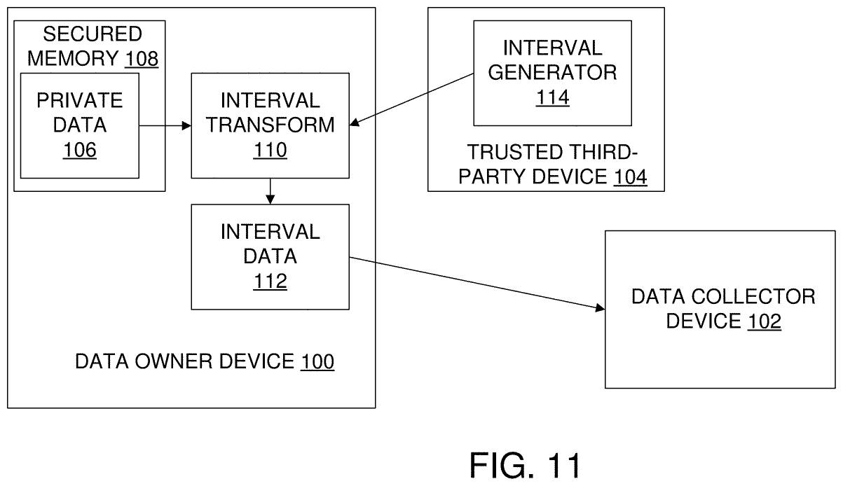

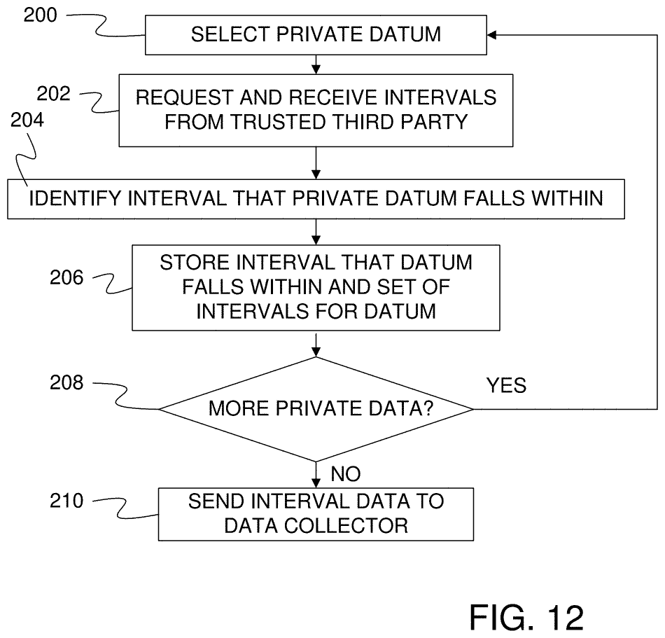

FIG. 11 provides a block diagram of a system 100 in accordance with one embodiment and FIG. 12 provides a flow diagram of a method of providing interval data to a data collector while securing private data from the data collector.

In FIG. 11, a data owner device maintains private data 106 in a secure memory 108 such that unauthorized computing systems and people are unable to access private data 106. Examples of private data include medical records and financial records. However, keeping such data secure results in the data being unavailable to third parties. As a result, third parties are unable to use the data to determine statistical distributions of the data, to determine relationships between different aspects of the data, or to train Artificial Intelligence models. Third party systems that perform these functions are referred to generically as data collector devices 102.

The present embodiments transform the private data into interval data 112 that can be shared with data collector devices 102 without exposing the private data itself. In particular, an interval transform 110 generates interval data 112 from private data 106 using the method of FIG. 12.

In step 200 of FIG. 12, interval transform 110 selects one datum of private data 106. At step 202, interval transform 110 requests and receives a set of intervals for the selected datum 106. In accordance with one embodiment, the set of intervals is defined by a set of anchor points, with each interval being defined from and including one anchor point and extending to just before the next anchor point. The set of anchor points, and thus the set of intervals, are randomly set for each selected datum 106 such that each datum has its own anchor points/intervals that differ from the anchor points/intervals of other private data 106. In accordance with one embodiment, interval transform 110 requests the intervals from an interval generator 114 executed by a trusted third-party device 104. In some embodiment, trusted third-party device 104 is independent of but trusted by both the data owner and the data collector. In other embodiments, data owner device 100 generates the anchor points/intervals itself.

At step 204, interval transform 110 determines which of the returned intervals the selected private datum 106 comes from. Interval transform 110 then stores as interval data 112, the identified interval that selected private datum 106 comes from together with the set of anchor points/intervals that were returned for the selected private datum at step 206. Interval transform 110 then determines if there are more private data 106 at step 208. When there are more private data, the next private datum is selected by returning to step 200. When all of private data 106 have been processed the interval data is sent to or made accessible to data collector device 102 while continuing to secure private data 106 from data collector device 102. Thus, data collector device 102 is only able to learn what intervals the private data was in and for each private datum, the set of intervals that were available for that datum.

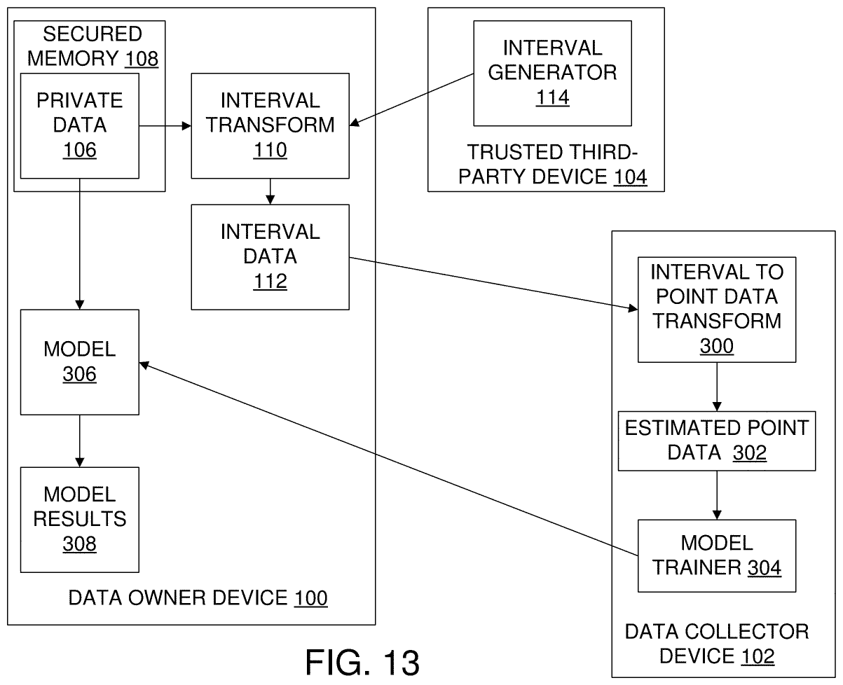

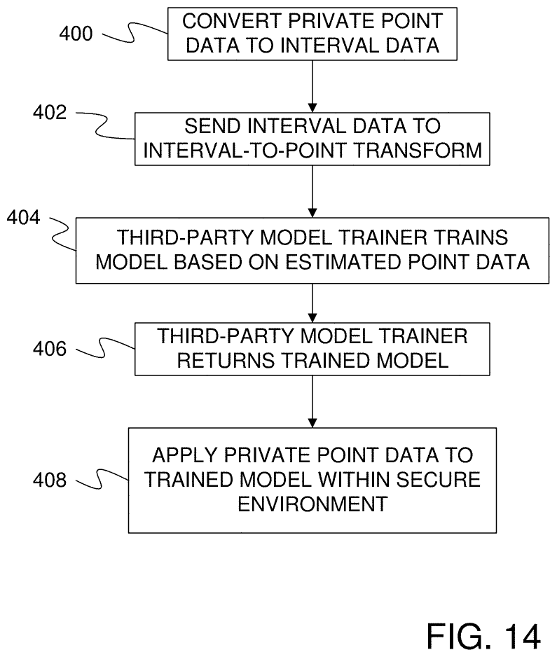

One example of a data collector device 102 is one that trains a model from the interval data. FIG. 13 provides a block diagram of a system that utilizes such a data collector device and FIG. 14 provides a flow diagram of a method of generating and using an Artificial Intelligence model using the system of FIG. 13.

In step 400 of FIG. 14, each datum in private data 106 is converted into interval data 112 by interval transform 110 using the process of FIG. 12 discussed above. At step 402, interval data 112 is provided to interval-to-point data transform 300 which estimates a point value for each interval. In accordance with one embodiment, this is done using on of the D transforms discussed above. The resulting estimated point data 302 is then used by model trainer 304 to produce a model 306 at step 404. Note that model 306 is not formed from private data 106 but instead is based on an estimated point data 302 that has a similar distribution to private data 106 but does not have the same values as private data 106. At step 406, model 306 is returned to data owner device 100. At step 408, data owner device 100 applies the same or additional private data 106 to model 306 to produce a model result 308. Alternatively, at step 406 model 306 is used in an Application Programming Interface (API) for not only the data owner but others such as government agencies, commercial companies, and research labs. These users can provide additional private data (data transformed into intervals) to the API to have the additional private data applied to the model.

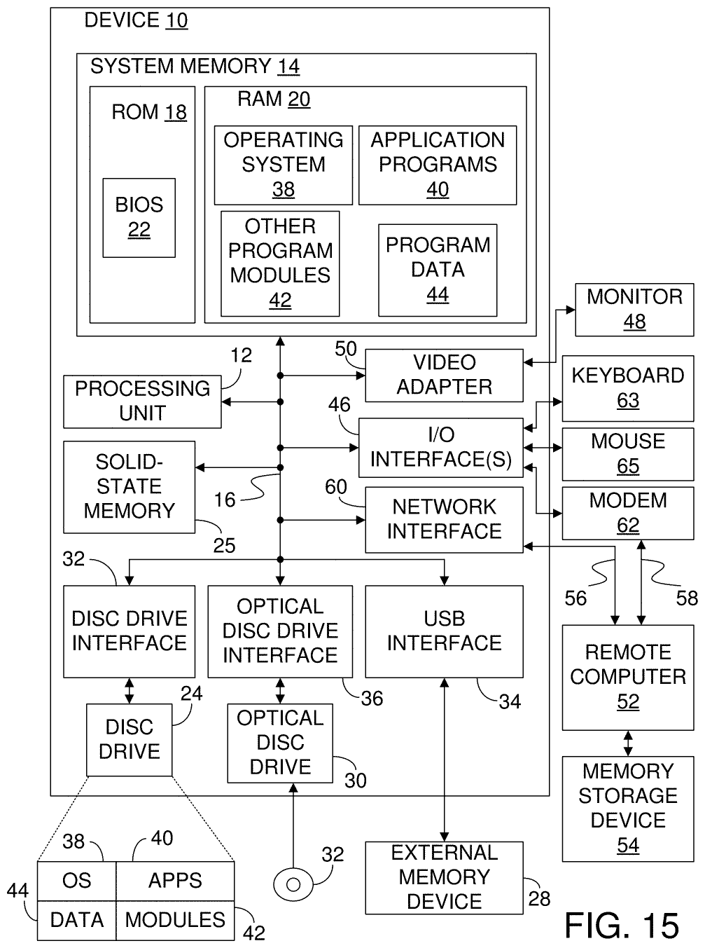

FIG. 15 provides an example of a computing device 10 that can be used as data owner device 100, data collector device 102 or trusted third-party device 104. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of modules discussed above. Program data 44 may include any data used by the systems and methods discussed above.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 15. The network connections depicted in FIG. 15 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 15 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

What is claimed is:

1. A method comprising:
for each of a plurality of values stored in a computer memory:
requesting a set of intervals for the value;
receiving the set of intervals such that different values have different sets of intervals;
determining which interval the value falls within; and
storing the interval that the value falls within as part of public interval data that does not identify the value.

2. The method of claim 1 further comprising providing the public interval data to a data collector.

3. The method of claim 2 wherein requesting a set of intervals comprises requesting the set of intervals from a third-party different than the data collector.

4. The method of claim 1 wherein the received set of intervals is independent of the value.

5. The method of claim 4 wherein the received set of intervals is randomly generated.

6. The method of claim 2 further comprising receiving a model trained by the data collector from the public interval data and applying values to the model to produce model results.

7. The method of claim 1 further comprising for each of the plurality of values, storing the set of intervals received for the private value as part of the public interval data.

8. A computer-implemented method comprising:
securing values from disclosure to a third party by performing steps for each value comprising:
obtaining at least two intervals for the value such that different ones of the values have different intervals;
determining which of the at least two intervals the value is found in; and
providing an indication of which of the at least two intervals the value is found in without providing the value itself to the third party.

9. The computer-implemented method of claim 8 further comprising providing the at least two intervals to the third party.

10. The computer-implemented method of claim 9 wherein the at least two intervals are randomly set for the value.

11. The computer-implemented method of claim 8 wherein the at least two intervals are determined independent of the value.

12. The computer-implemented method of claim 11 wherein obtaining the at least two intervals comprises obtaining the intervals from a trusted third party.

13. The computer-implemented method of claim 8 further comprising receiving a model from the third party that has been trained based on the indications of which intervals the values were found in.

14. The computer-implemented method of claim 13 further comprising applying the values to the received model to produce model results.

15. A system comprising:
a memory holding values in a secure manner to prevent disclosure of the values; and
a processor executing instructions to perform steps comprising:
for each of a plurality of the values held in a secure manner:
obtaining a set of intervals;
determining which interval the value is from;
storing the set of intervals and which interval the value is from in the memory; and
providing access to the set of intervals and the interval the value is from without providing access to the value itself.

16. The system of claim 15 wherein the set of intervals are determined independent of the value.

17. The system of claim 15 wherein obtaining a set of intervals comprises requesting a set of intervals from a second processor.

18. The system of claim 15 wherein the set of intervals is randomly produced.

19. The system of claim 15 further comprising receiving a model trained from the sets of intervals and the intervals the values are from.

20. The system of claim 19 further comprising applying the plurality of values to the model to form model outputs.
